(19) United States
(12) Patent Application Publication
(10) Pub. No.: US 2005/0129216 A1
(43) Pub. Date: Jun. 16, 2005

(54) Method and apparatus for supporting operator, operator supporting terminal, and computer product

(75) Inventor: Hidetoshi Tsujiuchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/001,638

(22) Filed: Dec. 2, 2004

Related U.S. Application Data
(63) Continuation of application No. PCT/JP03/11394, filed on Sep. 5, 2003.

(30) Foreign Application Priority Data
Sep. 6, 2002 (JP) 2002-261430

(51) Int. Cl. H04M 3/00; H04M 5/00; H04M 1/64

(52) U.S. Cl. 379/265.09; 379/67.1

(57) ABSTRACT

An operator supporting apparatus displays information for supporting an operator who talks over a telephone with a client in a call center on an operator terminal, and records a call between the operator and the client. A cooperation-control-information storing unit stores a call content identifier that is to be added to a call recording to specify a spot to be played when the call recorded is partially played, in association with an operation performed by the operator. An identifier specifying unit specifies, when the operator operates the operator terminal, the call content identifier corresponding to the operation performed by the operator. An identifier adding unit adds the call content identifier specified to the call recording.

### BACKGROUND OF THE INVENTION

1) Field of the Invention

The present invention relates to a technology for supporting an operator who works on a telephone with a client in a call center.

2) Description of the Related Art

Conventionally, in a call center, various types of information are displayed on an operator terminal to support an operator who talks over a telephone with a client (see, for example, Japanese Patent Application Laid-Open Publication No. 2003-219038). FIG. 24 is an example of a screen displayed on a conventional operator terminal.

A client information screen for displaying personal information of the client, a transaction screen to be used when the operator processes the matter of the client, and a dialog scenario screen for displaying dialog scenarios previously made by assuming the conversation with the client are displayed on the operator terminal, respectively independently.

The operator can process the matter of the client efficiently by obtaining the necessary information, while operating these screens. For example, when the operator selects a spot corresponding to the matter of the client on the dialog scenario screen, a dialog scenario normally talked for the matter is displayed. Therefore, the operator can lead the conversation with the client efficiently, by talking to the client according to the displayed dialog scenario.

All the conversation between the operator and the client is recorded, and used is for the post-processing for creating a correspondence record with the client by the operator and for checking the reception attitude of the operator (see, for example, “Database type call recording system Recware®”, searched on Aug. 22, 2003 (H15), Internet <http://www.hitachi-it.co.jp/products/cti/record/index.htm>).

However, since the operator mainly operates the transaction screen, concentrating on the talk with the client during the conversation, there is a problem in that it is difficult for the operator to operate the dialog scenario screen in parallel.

When the operator plays the call recording in the post-processing, it takes time to find the necessary spot, thereby causing a problem in that the call recording cannot be played efficiently.

### SUMMARY OF THE INVENTION

It is an object of the present invention to solve at least the above problems in the conventional technology.

An operator supporting apparatus according to one aspect of the present invention, which displays information for supporting an operator who talks over a telephone with a client in a call center on an operator terminal, and records a call between the operator and the client, includes a cooperation-control-information storing unit that stores a call content identifier that is to be added to a call recording to specify a spot to be played when the call recorded is partially played, in association with an operation performed by the operator on the operator terminal during the call; an identifier specifying unit that specifies, when the operator operates the operator terminal during the call, the call content identifier corresponding to the operation performed by the operator; and an identifier adding unit that adds the call content identifier specified by the identifier specifying unit to the call recording.

An operator support terminal according to another aspect of the present invention includes a first screen display unit that displays a transaction screen that is used when an operator processes a business of a client during a call with the client and a dialog scenario screen that is used when the operator uses a dialog scenario; a transmitting unit that transmits, to an operator supporting apparatus, the dialog scenario displayed on the dialog scenario screen and information on an operation performed by the operator during the call on the transaction screen, in association with each other; a receiving unit that receives, from the operator supporting apparatus, the dialog scenario screen specified by the information transmitted by the transmitting unit; and a second screen display unit that displays the dialog scenario received by the receiving unit on the dialog scenario screen.

An operator support method according to still another aspect of the present invention, which is for displaying information for supporting an operator who talks over a telephone with a client in a call center on an operator terminal, and recording a call between the operator and the client, includes specifying, when the operator operates the operator terminal during the call, a call content identifier corresponding to an operation performed by the operator by using a cooperation-control-information storing unit in which the call content identifier that is to be added to a call recording to specify a spot to be played when the call recorded is partially played is stored in association with the operation performed by the operator on the operator terminal during the call; and adding the call content identifier specified by the identifier specifying unit to the call recording.

An operator support method according to still another aspect of the present invention, which is for supporting an operator who talks over a telephone with a client in a call center by using an operator terminal that includes a transaction screen that is used when the operator processes a business of the client during a call with the client and a dialog scenario screen that is used when the operator uses a dialog scenario, includes transmitting, to an operator supporting apparatus, the dialog scenario displayed on the dialog scenario screen, and information of an operation performed by the operator during the call on the client information screen, in association with each other; receiving, from the operator supporting apparatus, the dialog scenario specified by the information transmitted; and displaying the dialog scenario received on the dialog scenario screen.

A computer-readable recording medium according to still another aspect of the present invention stores an operator supporting program according that causes a computer to execute the above operator support methods according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram of the concept for an operator supporting apparatus according to a first embodiment;

FIG. 2 is a functional block diagram of the system configuration of a call center system according to the first embodiment;

FIG. 3 is an example of a cooperation-control-information storing unit;

FIG. 4 is an example of a call IP address storage unit;

FIG. 5 is an example of a data structure of a tagged call recording stored in a call DB;

FIG. 6 is an example for explaining screen cooperation processing by a cooperation apparatus;

FIG. 7 is a flowchart of a processing procedure of the call center system according to the first embodiment;

FIG. 8 is a flowchart of a processing procedure of a dialog scenario information providing unit shown in FIG. 2;

FIG. 9 is a flowchart of a processing procedure of voice packet reception processing by a call managing unit shown in FIG. 2;

FIG. 10 is a flowchart of a processing procedure of tag reception processing by the call managing unit shown in FIG. 2;

FIG. 11 is an explanatory diagram of an example of adding a tag to the call recording stored in the call DB;

FIG. 12 is an explanatory diagram of an example of a dialog scenario displayed corresponding to an operation of an operator;

FIG. 13 is an explanatory diagram of an example of a transaction screen displayed corresponding to designation to display the dialog scenario by the operator;

FIG. 14 depicts a computer system that executes an operator supporting program according to the first embodiment;

FIG. 15 is a functional block diagram of the configuration of a main unit shown in FIG. 14;

FIG. 16 is a functional block diagram of the system configuration of a call center system according to a second embodiment;

FIG. 17 is a flowchart (1) for explaining the operation of the call center system according to the second embodiment;

FIG. 18 is a flowchart (2) for explaining the operation of the call center system according to the second embodiment;

FIG. 19 is a flowchart (3) for explaining the operation of the call center system according to the second embodiment;

FIG. 20 is a flowchart for explaining the details of an operation associated with an operator, in the call center system according to the second embodiment;

FIG. 21 is an example of a screen displayed on a client terminal according to the second embodiment;

FIG. 22 is an example of a screen displayed on an operator terminal according to the second embodiment;

FIG. 23 is an example of a log according to the second embodiment; and

FIG. 24 is an example of a screen displayed on a conventional operator terminal.

### DETAILED DESCRIPTION

Exemplary embodiments of a method and an apparatus for supporting an operator, an operator support terminal, and a computer product according to the present invention will be explained in detail with reference to the accompanying drawings.

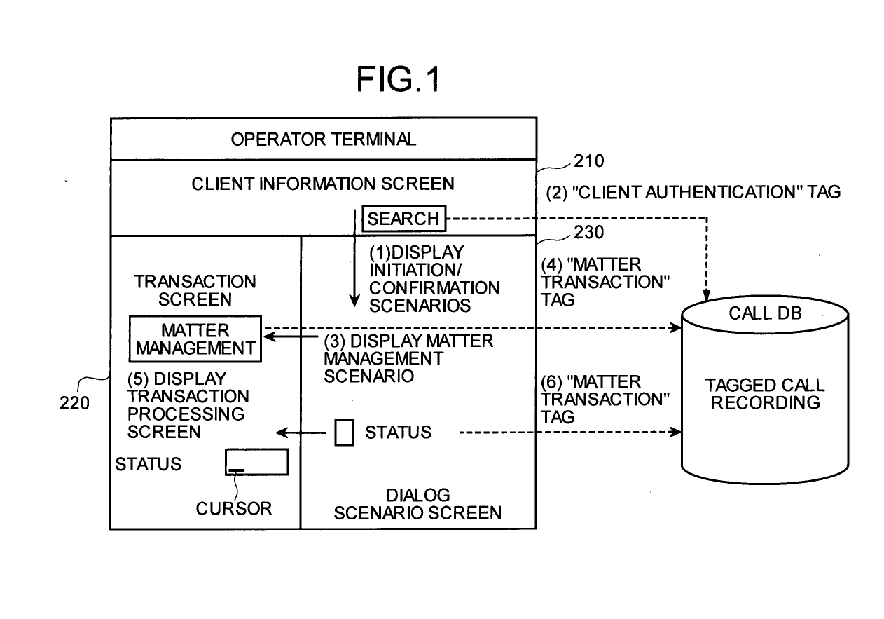

FIG. 1 is an explanatory diagram of the concept of the operator supporting apparatus according to a first embodiment of the present invention. A screen displayed on an operator terminal while an operator is talking over the telephone with a client, and a call database (DB) for storing the call between the operator and the client are shown. The operator supporting apparatus displays a client information screen 210 for displaying private information of the client on the operator terminal, a transaction screen 220 used when the operator processes the matter of the client, and a dialog scenario screen 230 for displaying dialog scenarios previously made by assuming the conversation with the clients.

When the operator operates the client information screen 210 during the call, the operator supporting apparatus automatically displays the dialog scenario relating to the operation performed by the operator on the client information screen 210, on the dialog scenario screen 230.

For example, when the operator starts talking with a client, and selects “search” for displaying the client information on the client information screen 210, if the client can be identified based on a caller ID of the terminal used by the client, the operator supporting apparatus displays the information of the identified client on the client information screen 210, but if the client cannot be identified based on the caller ID, displays a screen for registering the client as a new client.

At this time, if the client can be identified based on the caller ID, the operator supporting apparatus automatically displays a scenario for confirming the client on the dialog scenario screen 230, and if the client cannot be identified based on the caller ID, the operator supporting apparatus automatically displays a client registration initiation scenario ((1)). In other words, the operator supporting apparatus automatically displays an associated dialog scenario on the dialog scenario screen 230, in cooperation with the operation of the operator for selecting “search” on the client information screen 210.

The operator supporting apparatus also stores a “client authentication” tag in the call DB while recording the call between the client and the operator, in cooperation with an operation of the operator for selecting “search” on the client information screen 210 ((2)). In other words, the operator supporting apparatus adds an associated tag to the call being recorded in the call DB, in cooperation with an operation of the operator for selecting “search” on the client information screen 210. The tag herein stands for an identifier for identifying the content of the call. Thus, the operator supporting apparatus creates a tagged call recording by automatically adding the associated tag to the call recording, in cooperation with the operation of the operator.

As another example, when the operator selects “matter management” on the transaction screen 220, the operator supporting apparatus automatically displays a matter management scenario on the dialog scenario screen 230 ((3)). In other words, the operator supporting apparatus automatically displays an associated dialog scenario on the dialog scenario screen 230, in cooperation with the operation of the operator for selecting “matter management” on the transaction screen 220.

The operator supporting apparatus stores a “matter management” tag in the call DB while recording the call between the client and the operator, in cooperation with the operation of the operator for selecting “matter management” on the transaction screen 220 ((4)). In other words, the operator supporting apparatus adds an associated tag to the call being recorded in the call DB, in cooperation with the operation of the operator for selecting “matter management” on the transaction screen 220.

In contrast, when the operator selects, for example, “status” on the dialog scenario screen 230, the operator supporting apparatus automatically changes over the transaction screen 220 to a screen related to the status, and shifts a cursor to a position related to the status ((5)). In other words, the operator supporting apparatus automatically changes over the transaction screen 220 to the related screen and shifts the cursor to the related position, in cooperation with the operation of the operator for selecting “status” on the dialog scenario screen 230.

The operator supporting apparatus stores a “matter situation” tag in the call DB while recording the call between the client and the operator ((6)), in cooperation with the operation of the operator for selecting “status” on the dialog scenario screen 230. In other words, the operator supporting apparatus adds an associated tag to the call being recorded in the call DB, in cooperation with the operation of the operator for selecting “status” on the dialog scenario screen 230.

Thus, the operator supporting apparatus according to the first embodiment automatically displays the associated dialog scenario on the dialog scenario screen 230, in cooperation with the operation of the operator on the client information screen 210 or the transaction screen 220. Therefore, the operator can obtain the associated dialog scenario without operating the dialog scenario screen 230, thereby improving the work efficiency of the operator.

The operator supporting apparatus according to the first embodiment automatically adds a tag for identifying the content of the call to the call being recorded, in cooperation with the operation of the operator on the client information screen 210, the transaction screen 220, and the dialog scenario screen 230. Therefore, the operator can efficiently play the call recording in the post-processing, thereby improving the work efficiency of the operator.

The operator supporting apparatus according to the first embodiment automatically changes over the transaction screen 220 to the related screen and shifts the cursor to the related position, in cooperation with the selection of the dialog scenario by the operator on the dialog scenario screen 230. Therefore, the operator can omit the screen changeover operation on the transaction screen 220 or the cursor moving operation, thereby improving the work efficiency of the operator.

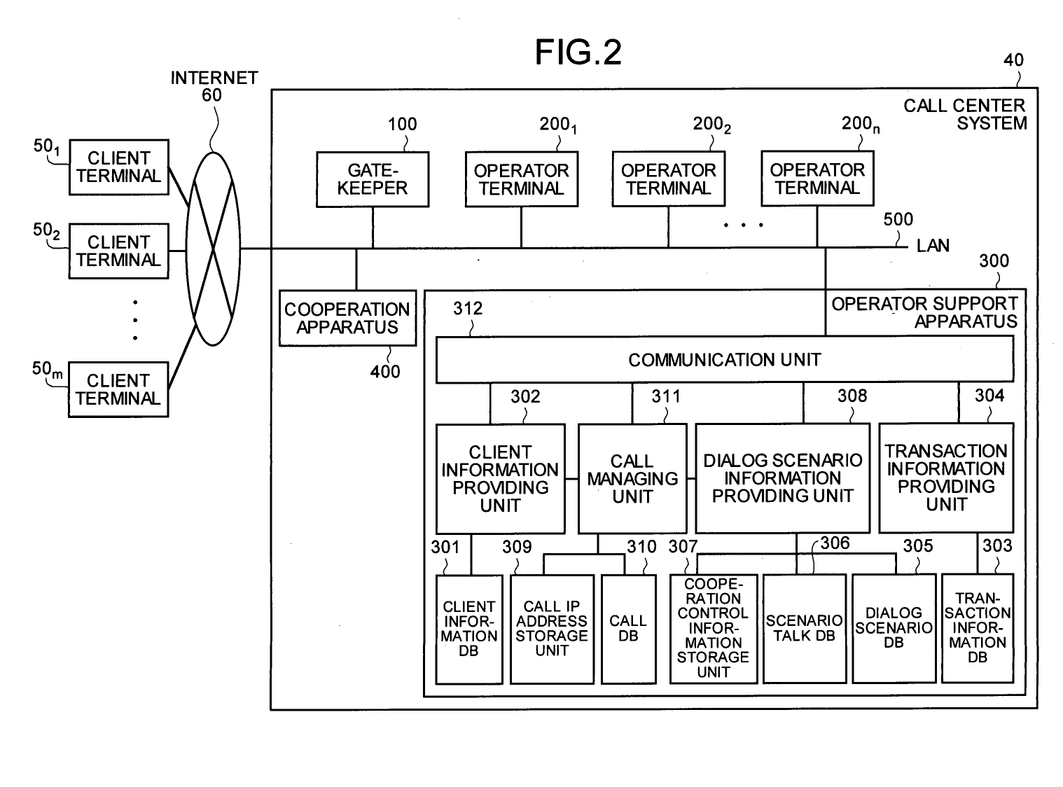

FIG. 2 is a functional block diagram of the system configuration of the call center system according to the first embodiment. A call center system 40 is constituted by connecting a gatekeeper 100, n operator terminals 200, to 200n, an operator supporting apparatus 300, and a cooperation apparatus 400 via a LAN 500. The call center system 40 is connected to m client terminals 50₁ to 50ₘ via the Internet 60. The client terminals 501 to 50m have a telephone function for talking over the telephone by using the Internet 60, such as an IP telephone, and clients can call the call center by using the client terminals 50₁ to 50ₘ to talk with the operator.

The gatekeeper 100 is an apparatus that receives calls from the client terminals 50₁ to 50ₘ to the call center and allocates each call to any one of the operator terminals 200, to 200n. The gatekeeper 100 instructs the allocated operator terminal and the client terminal whose call has been accepted to transmit a voice packet to be transmitted for the call also to the operator supporting apparatus 300.

That is, the client terminal whose call has been accepted transmits the voice of a client using the terminal to the allocated operator terminal by using the voice packet and also transmits the client's voice to the operator supporting apparatus 300. Further, the allocated operator terminal transmits the voice of the operator using the terminal to the client terminal by using the voice packet and also transmits the operator's voice to the operator supporting apparatus 300.

Thus, since the gatekeeper 100 instructs the allocated operator terminal and the client terminal whose call has been accepted to transmit the voice packet to be transmitted for the call also to the operator supporting apparatus 300, the operator supporting apparatus 300 can record the call between the client and the operator.

The operator terminals 200₁ to 200ₙ are apparatuses that have a telephone function for the operator to talk over the telephone with the client. Since the operator terminals 200₁ to 200ₙ have the same configuration and function, the operator terminal 200₁ will be explained as an example. Further, since the client terminals 50₁ to 50ₘ have the same configuration and function, the client terminal 50₁ will be explained as an example.

The operator terminal 200₁ has an input device that inputs the matter of the client and the like, the client information screen 210, the transaction screen 220, and a display device that displays information provided by the operator supporting apparatus 300 on the dialog scenario screen 230.

The operator talks over the telephone with a client, using the operator terminal 200₁ while referring to the information provided by the operator supporting apparatus 300, and inputs the matter of the client. The information input by the operator is transmitted to the operator supporting apparatus 300 and stored in the database.

The operator supporting apparatus 300 provides information for supporting the operator in response to the operator's request from the operator terminal 200₁, and stores the client information input by the operator terminal 200₁ and the matter of the client in the database.

The cooperation apparatus 400 mediates an information request from the operator terminal 200₁ to the operator supporting apparatus 300 and the information provided by the operator supporting apparatus 300 to the operator terminal 200₁.

In other words, when requesting the information with respect to the operator supporting apparatus 300, the operator terminal 200₁ transmits the information request to the cooperation apparatus 400, instead of directly transmitting the information request to the operator supporting apparatus 300. When providing the information in response to the information request from the operator terminal 200₁, the operator supporting apparatus 300 transmits the information to the cooperation apparatus 400, instead of directly transmitting the information to the operator terminal 200₁. The details of the processing by the cooperation apparatus 400 will be explained later.

The operator supporting apparatus 300 includes a client information DB 301, a client information providing unit 302, a transaction information DB 303, a transaction information providing unit 304, a dialog scenario DB 305, a scenario talk DB 306, a cooperation-control-information storing unit 307, a dialog scenario information providing unit 308, a call IP address storage unit 309, a call DB 310, a call managing unit 311, and a communication unit 312.

The client information DB 301 is a database for storing private information of the client. Specifically, in the client information DB 301, information such as a client ID for identifying the client, a caller ID of the client terminal used by the client, name, date of birth, gender, address, telephone number, place of work, and type of business is stored for each client.

The client information providing unit 302 is a processor that provides the private information of clients stored in the client information DB 301, in response to a request from the operator terminal 200₁. The information provided by the client information providing unit 302 is displayed on the client information screen 210 of the operator terminal 200₁.

When providing the client information for the first time, the client information providing unit 302 receives the IP addresses of the client terminal and the operator terminal from the operator terminal 200₁, and passes the IP addresses to the call managing unit 311 together with the client ID.

The transaction information DB 303 is a database for storing the information relating to the client's matter. Specifically, in the transaction information DB 303, matters such as inquiries, complaints, orders made by the client to the call center are stored for each client. Further, for each matter, a matter ID for identifying the matter, matter name, status, time limit, goods, and the name of a person in charge are stored.

The transaction information providing unit 304 is a processor that provides information relating to the client's matter stored in the transaction information DB 303, in response to a request from the operator terminal 200₁. The information provided by the transaction information providing unit 304 is displayed on the transaction screen 220 of the operator terminal 200₁. The information input by the operator on the transaction screen 220 is stored in the transaction information DB 303 by the transaction information providing unit 304.

The dialog scenario DB 305 is a database for storing dialog scenarios previously made by assuming the conversation with the clients. Specifically, in the dialog scenario DB 305, dialog scenarios for confirming the customer, managing the matters, receiving orders, receiving complaints, receiving inquiries for goods, and the like are stored in a tree structure.

The scenario talk DB 306 is a database for storing spoken conversation, corresponding to the scenario at the end of the tree structure of the dialog scenario stored in the dialog scenario DB 305. For example, as the dialog scenario for greeting, spoken conversation such as “I am sorry to have kept you waiting. I am XX, person in charge.” is stored, and as the dialog scenario for matter management relating to queries, spoken conversation such as “Have you found anything?” is stored.

The cooperation-control-information storing unit 307 stores the information for adding an associated tag to the call recording as well as displaying the relevant dialog scenario on the dialog scenario screen 230, in cooperation with the operation of the operator on the client information screen 210 and the transaction screen 220. The cooperation-control-information storing unit 307 is also used when the transaction screen 220 is changed over to shift the position of the cursor, in cooperation with the designation of the dialog scenario by the operator on the dialog scenario screen 230.

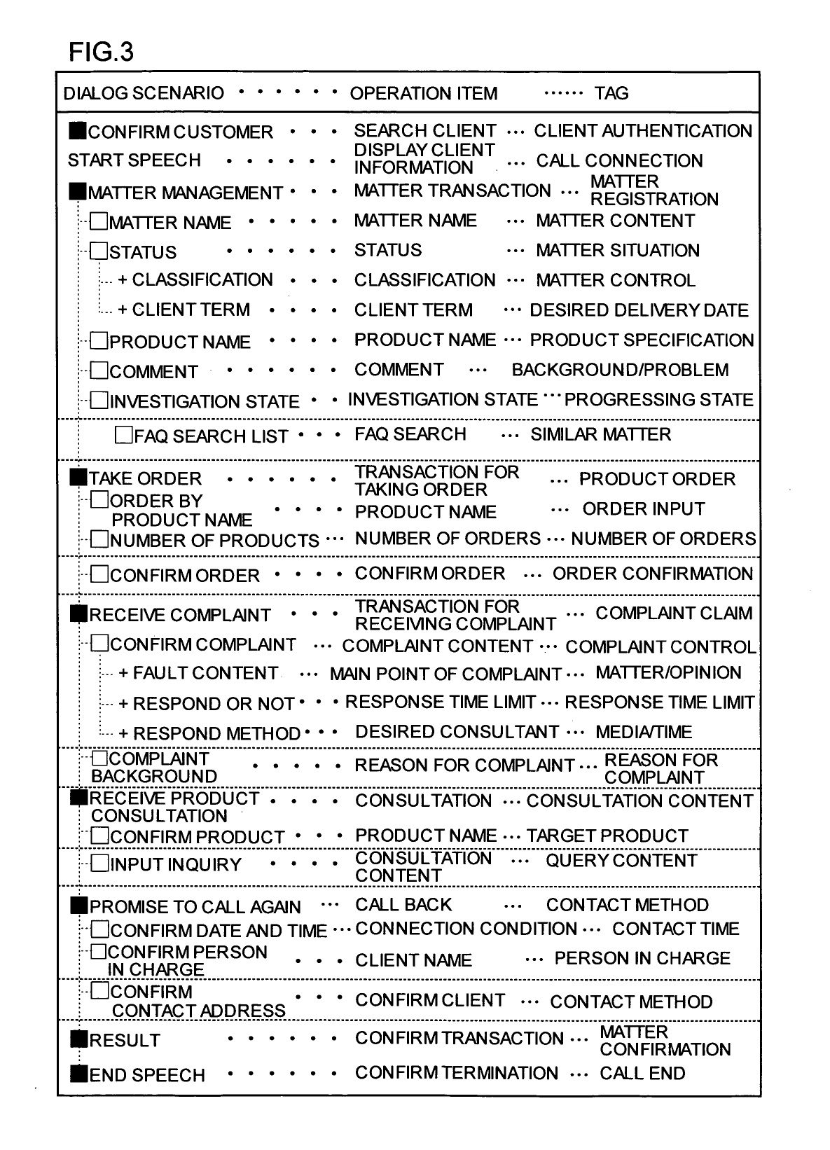

FIG. 3 is an example of the cooperation-control-information storing unit 307. As shown in the drawing, the cooperation-control-information storing unit 307 stores the dialog scenarios, operation items, and tags, corresponding to one another for each operation of the operator.

For example, a dialog scenario for “confirming customer” and a “client authentication” tag correspond to the operation item “client search”. Further, a dialog scenario for “status” and a “matter situation” tag correspond to the operation by which the operator inputs data to “status”, being one item in the matter management, on the transaction screen 220.

Thus, since the cooperation-control-information storing unit 307 stores the dialog scenarios, operation items, and tags corresponding to one another, a tag corresponding to the operation of the operator can be added to the call recording, and the client information screen 210, the transaction screen 220, and the dialog scenario screen 230 can be displayed in cooperation with one another.

The dialog scenario information providing unit 308 is a processor that provides information for the dialog scenario stored in the dialog scenario DB 305 and the scenario talk DB 306 in response to a request from the operator terminal 200₁. The information provided by the dialog scenario information providing unit 308 is displayed on the dialog scenario screen 230 of the operator terminal 200₁.

The dialog scenario information providing unit 308 also receives the information for the operation of the operator on the client information screen 210 and the transaction screen 220 from the cooperation apparatus 400. When having received the information for the operation of the operator from the cooperation apparatus 400, the dialog scenario information providing unit 308 obtains the dialog scenario corresponding to the operation of the operator by using the cooperation-control-information storing unit 307, and transmits the obtained information for the dialog scenario to the cooperation apparatus 400.

The dialog scenario information providing unit 308 obtains a tag corresponding to the operation of the operator by using the cooperation-control-information storing unit 307, and passes the obtained tag to the call managing unit 311, together with the IP address of the operator terminal 200₁, so as to add the tag to the call recording.

When providing the information for the dialog scenario, the dialog scenario information providing unit 308 obtains an operation item corresponding to the dialog scenario by using the cooperation-control-information storing unit 307, and transmits the obtained information for the operation item to the cooperation apparatus 400.

Thus, the dialog scenario information providing unit 308 transmits the dialog scenario corresponding to the operation of the operator on the client information screen 210 and the transaction screen 220 to the cooperation apparatus 400, by using the correspondence of the dialog scenarios, the operation items, and the tags stored in the cooperation-control-information storing unit 307, and passes the tag to the call managing unit 311. As a result, the operator supporting apparatus 300 can automatically display the dialog scenario in cooperation with the operation of the operator on the client information screen 210 and the transaction screen 220, and add a tag to the call recording.

Since the dialog scenario information providing unit 308 transmits the operation item corresponding to the designation of the dialog scenario by the operator, by using the correspondence of the dialog scenarios and the operation items stored in the cooperation-control-information storing unit 307, the operator supporting apparatus 300 can change over the transaction screen 220 and shift the cursor, in cooperation with the display of the dialog scenario.

The call IP address storage unit 309 stores information for identifying from which of the calls from the clients a voice packet is based on a sender IP address included in the voice packet.

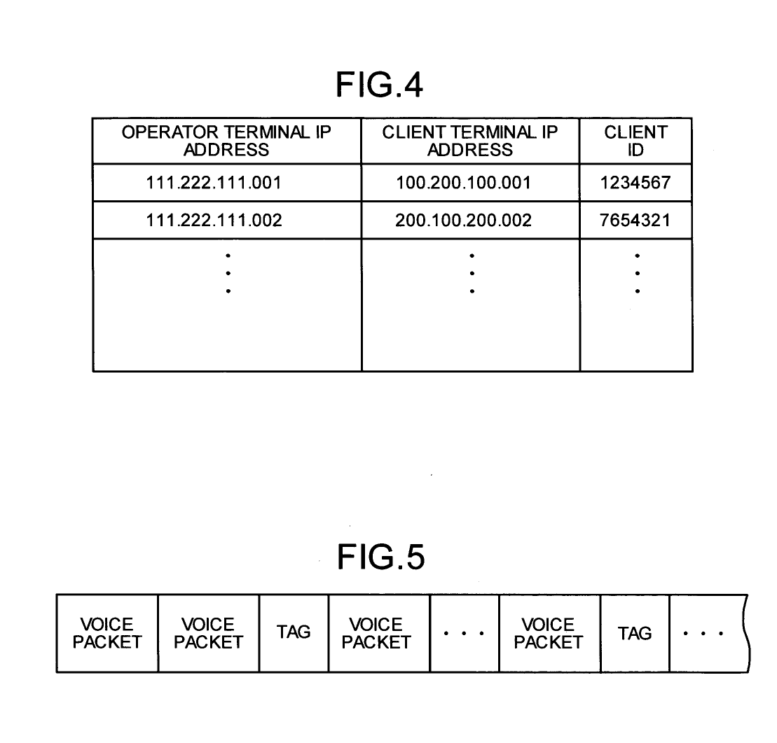

FIG. 4 is an example of the call IP address storage unit 309. As shown in the drawing, the call IP address storage unit 309 stores an IP address of the operator terminal, an IP address of the client terminal, and the client ID, corresponding to one another, for each client during call.

For example, a client ID of a call between an operator terminal having an IP address of “111.222.111.001” and a client terminal having an IP address of “100.200.100.001” is “1234567”, and a client ID of a call between an operator terminal having an IP address of “111.222.111.002” and a client terminal having an IP address of “200.100.200.002” is “7654321”.

The call DB 310 is a database for storing the call recording between the operator and the client. FIG. 5 is one example of data structure of tagged call recording stored in the call DB 310. As shown in the drawing, in the call recording, voice packets of the operator and the clients, and tags are recorded in the order of reception by the call managing unit 311.

The call managing unit 311 is a processor that receives the voice packets from the client terminal 50₁ and the operator terminal 200₁, and stores the voice packets in the call DB 310. In other words, the call managing unit 311 receives the IP addresses and the client IDs of the client terminal 50₁ and the operator terminal 200₁, which initiate a call, from a client information providing unit 302, and registers those in the call IP address storage unit 309. The call managing unit 311 obtains the client ID from a sender IP address included in the voice packets received from the client terminal 50₁ and the operator terminal 200₁, by using the call IP address storage unit 309, and stores the voice packets in the call DB 310, as the call of the obtained client ID.

The call managing unit 311 also receives the IP address and the tag of the operator terminal 200₁ from the dialog scenario information providing unit 308, to obtain the client ID from the IP address of the operator terminal 200₁, by using the call IP address storage unit 309, and adds the tag to the call recording of the obtained client ID.

Since the call managing unit 311 adds the tag to the call recording, when playing the call with the client in the post-processing, the operator can easily find the spot to be played, thereby improving efficiency of the post-processing performed by the operator.

The communication unit 312 is a processor that communicates with the gatekeeper 100, the operator terminal 200₁, and the cooperation apparatus 400 via the LAN 500. The communication unit 312 also communicates with the client terminal 50₁ via the LAN 500 and the Internet 60.

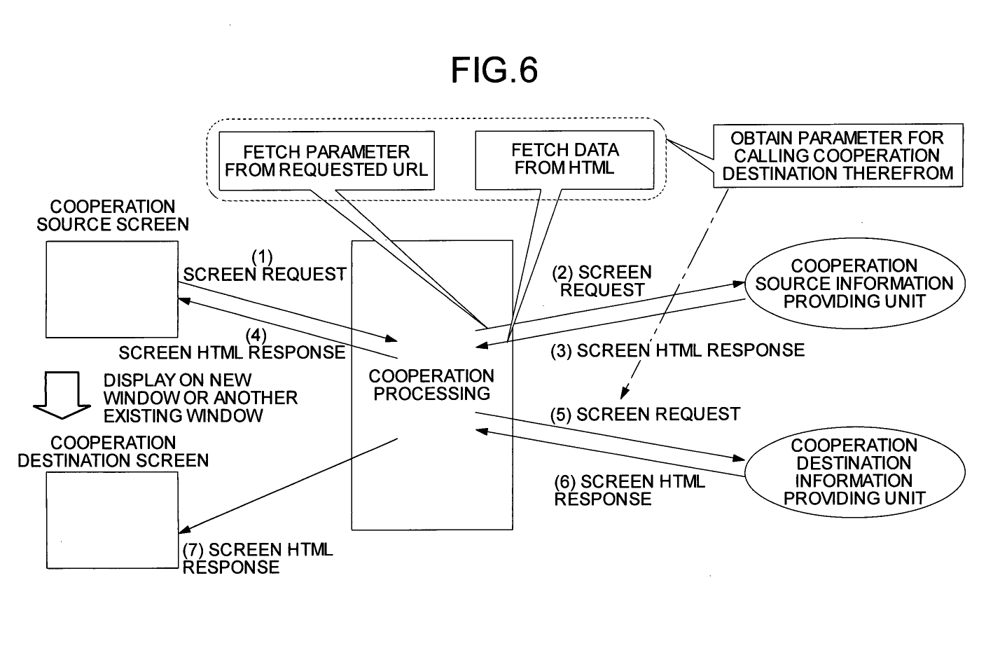

FIG. 6 is one example for explaining the screen cooperation processing by the cooperation apparatus 400. The processing by the cooperation apparatus 400 when the operator operates the client information screen 210, the transaction screen 220, or the dialog scenario screen 230 from the operator terminal 200₁ is shown.

When the operator operates the cooperation source screen, the processor for the cooperation source screen transmits the URL corresponding to the operation of the operator to the cooperation apparatus 400, to issue a screen request (1). The cooperation apparatus 400 fetches the parameter necessary for the cooperation from the received URL, and transmits the screen request to the cooperation source information providing unit that provides the screen information of the operator supporting apparatus 300 (2).

The parameter necessary for the cooperation includes the client ID and the like. When the cooperation source screen is the client information screen 210, the cooperation source information providing unit is the client information providing unit 302, and when the cooperation source screen is the transaction screen 220, the cooperation source information providing unit is the transaction information providing unit 304. Further, when the cooperation source screen is the dialog scenario screen 230, the cooperation source information providing unit is the dialog scenario information providing unit 308.

When having received the screen HTML response transmitted by the cooperation source information providing unit (3), the cooperation apparatus 400 transfers the received screen HTML response to the processor for the cooperation source screen (4), and fetches data necessary for cooperation from the screen HTML response. Here, the cooperation data fetched from the screen HTML response includes operation items and the like.

The cooperation apparatus 400 then transmits the parameter fetched from the URL and the cooperation data fetched from the screen HTML response to the cooperation destination information providing unit specified from the URL and the screen HTML response, and issues a screen request (5) for a screen to be displayed on the cooperation destination screen. When having received the screen HTML response transmitted from the cooperation destination information providing unit (6), the cooperation apparatus 400 transfers the received screen HTML response to the processor for the cooperation destination screen (7).

For example, when the cooperation source screen is the transaction screen 220, and the operator requests a screen for “matter transaction” on the transaction screen 220, the URL in which the information of the matter management is stored is transmitted to the cooperation apparatus 400 as the screen request, together with the client ID (1). The cooperation apparatus 400 then fetches the client ID, and transmits the screen request to the transaction information providing unit 304 in the operator supporting apparatus 300 (2).

When having received the screen HTML response transmitted from the transaction information providing unit 304 (3), the cooperation apparatus 400 transfers the received screen HTML response to the transaction screen 220 (4), and transmits the client ID and the “matter transaction” in the operation item, being data necessary for cooperation, to the dialog scenario information providing unit 308, to issue a screen request for a screen to be displayed on the dialog scenario screen 230 (5). When having received the information relating to the “matter management” in the dialog scenario transmitted by the dialog scenario information providing unit 308 (6), the cooperation apparatus 400 transfers the received information to the dialog scenario display screen 230 (7).

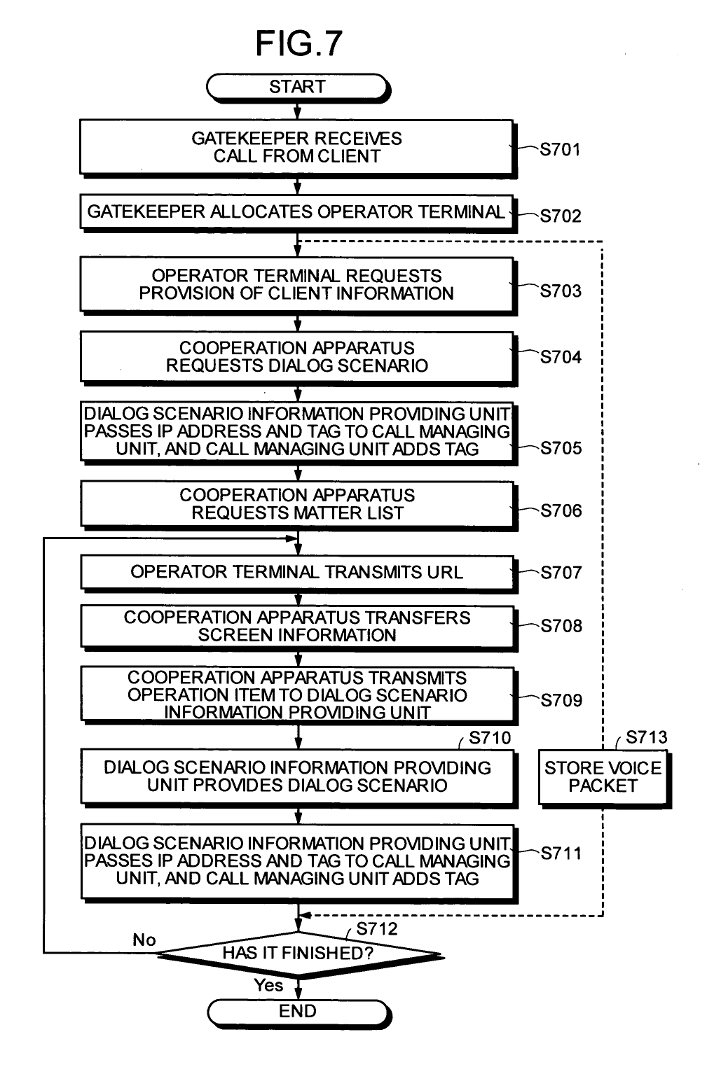

FIG. 7 is a flowchart of the processing procedure of the call center system 40 according to the first embodiment. The call center system 40 accepts a call from a client by the gatekeeper 100 (step S701), and allocates an operator corresponding to the accepted call, that is, an operator terminal 200₁ (step S702).

When the operator selects “search” on the operator terminal 200₁ to request the client information, while talking with the client, the operator terminal 200₁ requests the cooperation apparatus 400 to provide the client information (step S703). The cooperation apparatus 400 then requests the client information to the client information providing unit 302 in the operator supporting apparatus 300, and transfers the client information received from the client information providing unit 302 to the client information screen 210 of the operator terminal 200₁.

The cooperation apparatus 400 transmits “client search” to the dialog scenario information providing unit 308 in the operator supporting apparatus 300, to request the dialog scenario corresponding to the operation item “client search” (step S704). The dialog scenario information providing unit 308 then transmits the “client authentication” talk script to the cooperation apparatus 400, and passes the IP address of the operator terminal 200₁ and the “client authentication” tag to the call managing unit 311. The call managing unit 311 obtains the client ID from the IP address by using the call IP address storage unit 309 to add the “client authentication” tag to the call recording of the obtained client ID (step S705).

The cooperation apparatus 400 requests information relating to the matter list to the transaction information providing unit 304 in the operator supporting apparatus 300 (step S706), and transfers the information relating to the matter list received from the transaction information providing unit 304 to the transaction screen 220 of the operator terminal 200₁.

When the operator operates the transaction screen 220, and the operator terminal 200₁ transmits the URL corresponding to the operation of the operator to the cooperation apparatus 400 (step S707), the cooperation apparatus 400 transmits the URL to the transaction information providing unit 304. When having received the screen information from the transaction information providing unit 304, the cooperation apparatus 400 transfers the received screen information to the operator terminal 200₁ (step S708).

The cooperation apparatus 400 transmits the operation item corresponding to the operation of the operator on the transaction screen 220 to the dialog scenario information providing unit 308 (step S709), and the dialog scenario information providing unit 308 provides the dialog scenario corresponding to the operation item to the operator terminal 200₁ via the cooperation apparatus 400 (step S710).

The dialog scenario information providing unit 308 passes the tag corresponding to the operation item and the IP address of the operator terminal 200₁ to the call managing unit 311, and the call managing unit 311 obtains the client ID from the IP address by using the call IP address storage unit 309, to add the tag to the call recording of the obtained client ID (step S711).

During the operator operates the operator terminal 200₁ while talking with the client (step S712, NO), control returns to step S707 to repeat the above processing. On the other hand, when the operator finishes talking with the client and performs termination operation from the operator terminal 200₁ (step S712, YES), the processing is finished.

In the call center system 40, the call managing unit 311 receives a voice packet for the call between the operator and the client, in parallel with the processing at steps from S703 to S711, and stores the voice packet in the call DB 310 as call recording (step S713).

Here, an example in which the operator operates the transaction screen 220 is explained. However, when the operator designates a dialog scenario on the dialog scenario screen 230, the dialog scenario is displayed on the dialog scenario screen 230 of the operator terminal 200₁, the corresponding transaction information is displayed on the transaction screen 220, and the corresponding tag is added to the call recording.

Thus, when the operator operates the transaction screen 220 of the operator terminal 200₁, the call center system 40 automatically outputs the talk script corresponding to the operation of the operator on the transaction screen 220 onto the dialog scenario screen 230. As a result, the operator can obtain the necessary talk script without operating the dialog scenario screen 230.

When the operator operates the transaction screen 220 of the operator terminal 200₁, the call center system 40 automatically adds a tag corresponding to the operation on the transaction screen 220 to the call recording. As a result, the operator can easily find the spot to be played in the call in the post-processing.

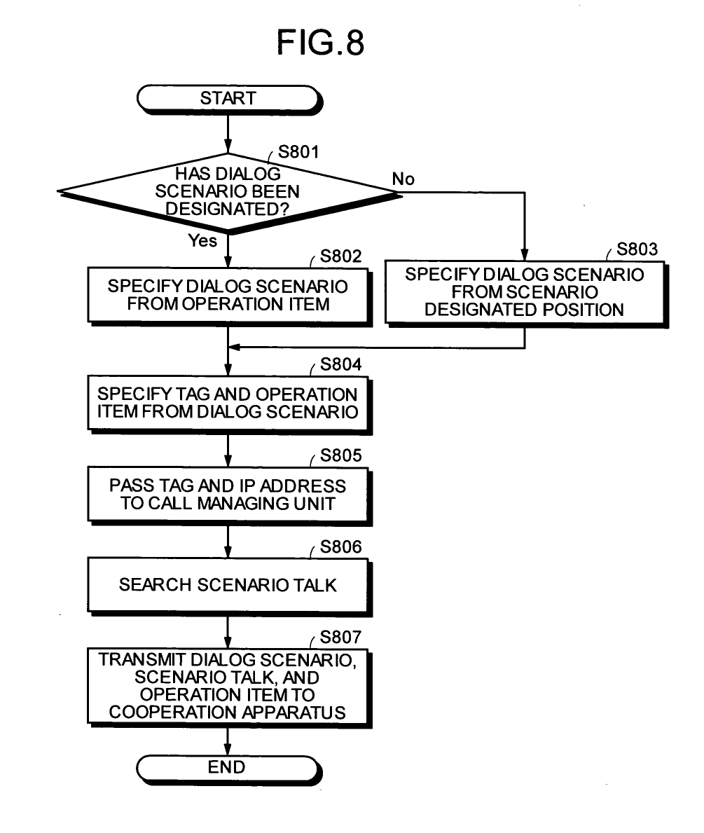

FIG. 8 is a flowchart of the processing procedure of the dialog scenario information providing unit 308 shown in FIG. 2. The dialog scenario information providing unit 308 determines whether it is a case in which the cooperation apparatus 400 requests a display of the dialog scenario in cooperation with other screen displays, or a case in which the operator designates the dialog scenario to be displayed on the dialog scenario screen 230 (step S801).

As a result, when the cooperation apparatus 400 requests a display of the dialog scenario in cooperation with other screen displays, the dialog scenario information providing unit 308 specifies the dialog scenario corresponding to the operation item received from the cooperation apparatus 400, by using the cooperation-control-information storing unit 307 (step S802). On the other hand, when the operator designates the dialog scenario to be displayed on the dialog scenario screen 230, the dialog scenario information providing unit 308 specifies the dialog scenario from a scenario designated position (step S803).

The dialog scenario information providing unit 308 then specifies the tag corresponding to the specified dialog scenario and the operation item by using the cooperation-control-information storing unit 307 (step S804), and passes the specified tag to the call managing unit 311, together with the IP address of the operator terminal 200₁ so as to add the specified tag to the call recording (step S805). Further, the dialog scenario information providing unit 308 searches a scenario talk from the scenario talk DB 306 (step S806), and transmits the dialog scenario, the scenario talk, and the operation item to the cooperation apparatus 400 (step S807).

Thus, since the dialog scenario information providing unit 308 specifies the tag and the dialog scenario corresponding to the operation of the operator by using the cooperation-control-information storing unit 307, the operator supporting apparatus 300 can add the tag to the call recording, and automatically display the dialog scenario corresponding to the operation of the operator.

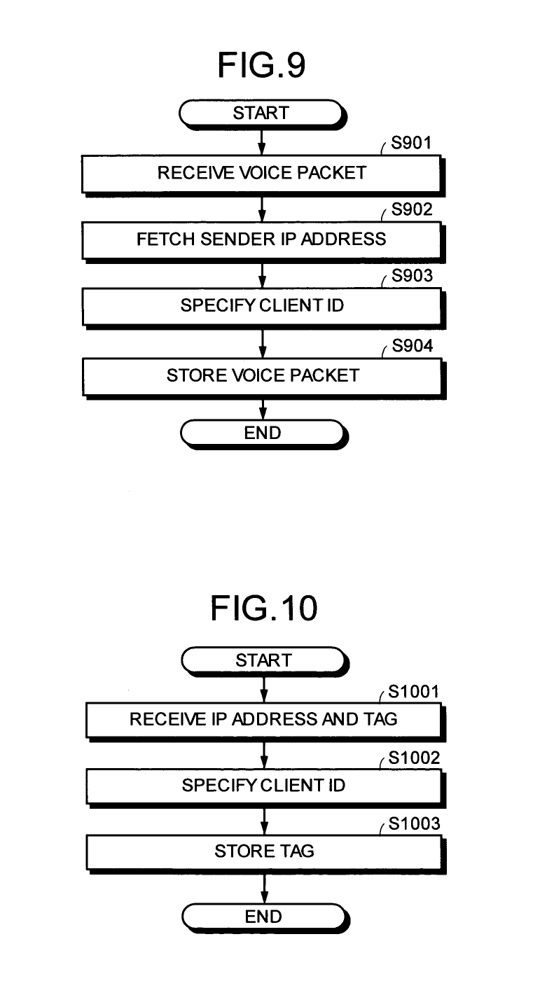

FIG. 9 is a flowchart of the processing procedure of the voice packet reception processing by the call managing unit 311 shown in FIG. 2. Upon reception of the voice packet via the communication unit 312 (step S901), the call managing unit 311 fetches the sender IP address from the received voice packet (step S902).

The call managing unit 311 then specifies the client ID corresponding to the fetched IP address by using the call IP address storage unit 309 (step S903), and stores the voice packet in the call DB 310 as the call recording of the specified client ID (step S904).

FIG. 10 is a flowchart of a processing procedure of the tag reception processing by the call managing unit 311 shown in FIG. 2. Upon reception of the tag and the IP address via the communication unit 312 (step S1001), the call managing unit 311 specifies the client ID corresponding to the received IP address by using the call IP address storage unit 309 (step S1002), and stores it in the call DB 310 as a tag to be added to the call recording of the specified client ID (step S1003).

Thus, since the call managing unit 311 receives the voice packet and the tag and stores them in the call DB 310 as the call recording, in order of reception, a tagged call recording can be created.

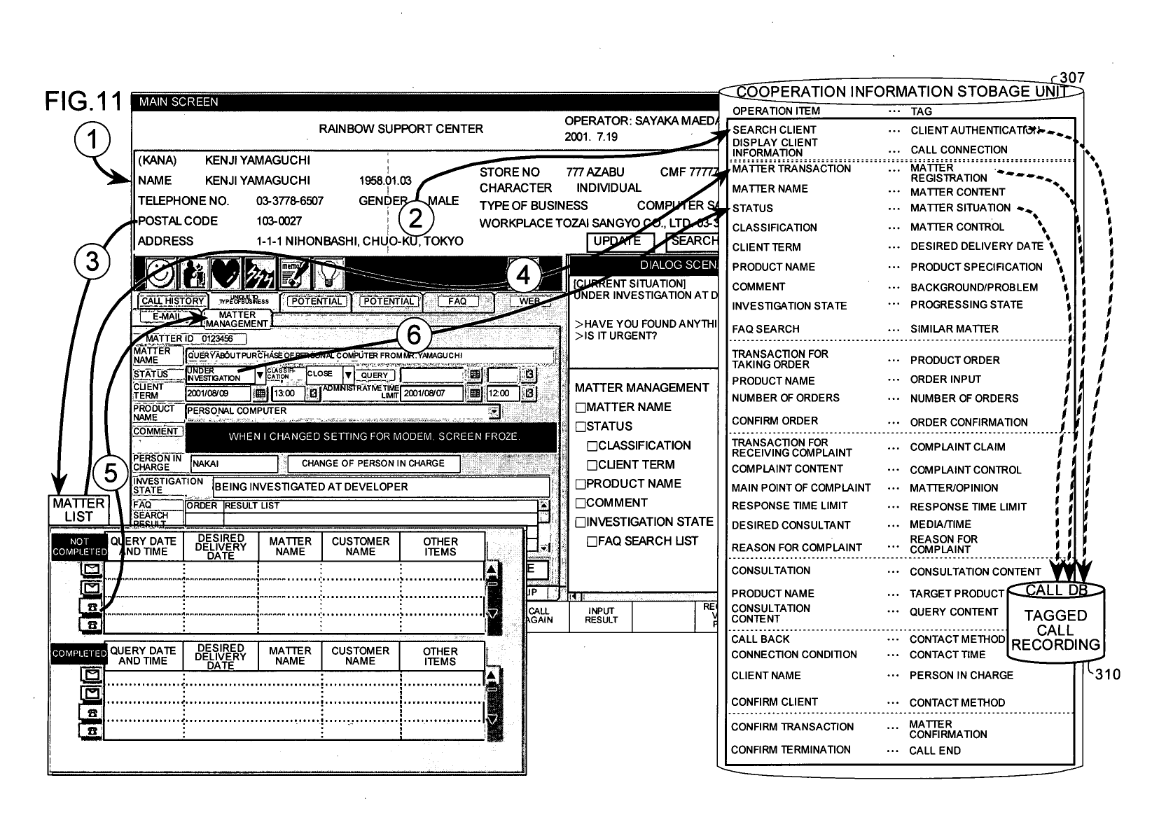

FIG. 11 is an explanatory diagram of an example of adding a tag to the call recording stored in the call DB 310. Here, an example in which the information for a client who places a call to the call center is already in the client DB 301 will be explained.

When a call of the client is allocated to an operator ((1)), the operator searches the client ID based on the caller ID to display the client information on the client information screen 210 of the operator terminal 200₁, and sets it in the client information providing unit 302 ((2)). At this time, the operator supporting apparatus 300 adds the “client authentication” tag corresponding to the operation item “client search” stored in the cooperation-control-information storing unit 307 to the call recording currently being recorded in the call DB 310.

The operator supporting apparatus 300 then displays the matter list for the client on the transaction screen 220 ((3)), and adds a “matter registration” tag corresponding to the operation item “matter transaction” stored in the cooperation-control-information storing unit 307 to the call recording currently being recorded in the call DB 310 ((4)). When the operator selects a matter ((5)), and selects “status” on the transaction screen 220, the operator supporting apparatus 300 adds a “matter situation” tag corresponding to the operation item “status” stored in the cooperation-control-information storing unit 307 to the call recording currently being recorded in the call DB 310 ((6)).

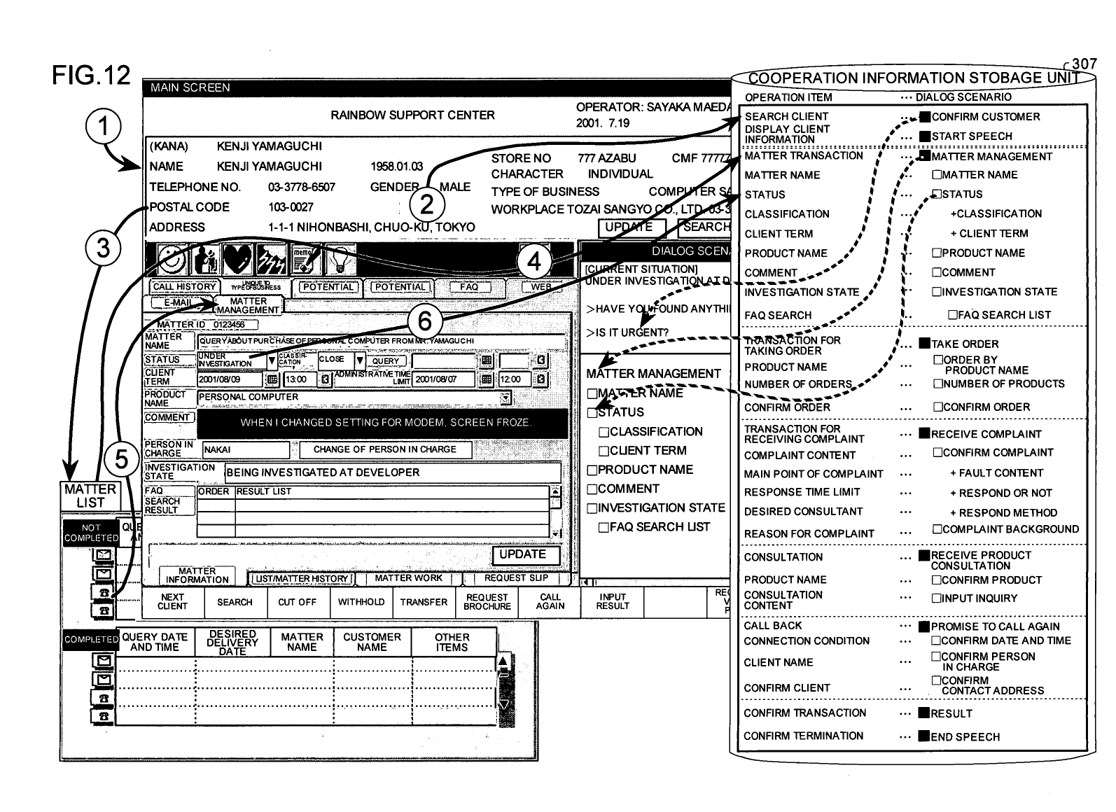

FIG. 12 is an explanatory diagram of an example of a dialog scenario displayed corresponding to the operation of the operator. Here, an example in which the information for a client who places a call to the call center is already in the client DB 301 will be explained.

When a call of the client is allocated to an operator ((1)), the operator searches the client ID based on the caller ID to display the client information on the client information screen 210 of the operator terminal 200₁, and sets it in the client information providing unit 302 ((2)). At this time, the operator supporting apparatus 300 displays the dialog scenario “client confirmation” corresponding to the operation item “client search” stored in the cooperation-control-information storing unit 307 on the dialog scenario screen 230.

The operator supporting apparatus 300 then displays the matter list for the client on the transaction screen 220 ((3)), and displays the dialog scenario “matter management” corresponding to the operation item “matter transaction” stored in the cooperation-control-information storing unit 307 on the dialog scenario screen 230 ((4)). When the operator selects a matter ((5)), and selects “status” on the transaction screen 220, the operator supporting apparatus 300 displays the dialog scenario “status” corresponding to the operation item “status” stored in the cooperation-control-information storing unit 307 on the dialog scenario screen 230.

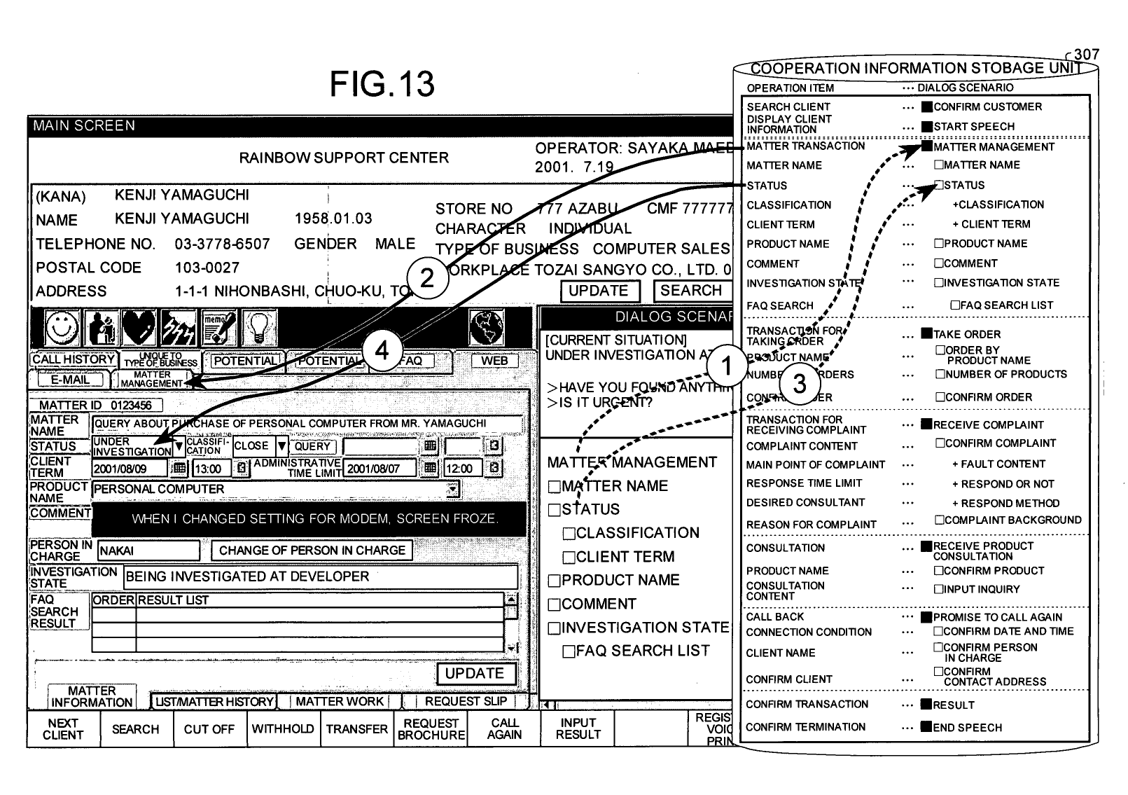

FIG. 13 is an explanatory diagram of the example of the transaction screen 220 displayed corresponding to designation to display the dialog scenario by the operator. When the operator designates “matter management” on the dialog scenario screen 230 ((1)), the operator supporting apparatus 300 displays a screen for the operation item “matter transaction” corresponding to the dialog scenario “matter management” stored in the cooperation-control-information storing unit 307 on the transaction screen 220 ((2)).

When the operator designates “status” on the dialog scenario screen 230 ((3)), the operator supporting apparatus 300 automatically shifts the cursor to the position of the status item on the screen displayed on the transaction screen 220, based on the operation item “status” corresponding to the dialog scenario “status” stored in the cooperation-control-information storing unit 307 ((4)).

According to the first embodiment, the cooperation-control-information storing unit 307 in the operator supporting apparatus 300 stores the dialog scenarios and tags corresponding to each other. When the dialog scenario information providing unit 308 displays the dialog scenario on the dialog scenario screen 230, the operator supporting apparatus 300 specifies the tag corresponding to the dialog scenario by using the correspondence information stored in the cooperation-control-information storing unit 307, and passes the specified tag to the call managing unit 311, together with the IP address of the operator terminal. The call managing unit 311 then adds the tag to the call recording of the client ID corresponding to the received IP address. As a result, the operator can play the call recording efficiently, by using the added tag.

According to the first embodiment, the cooperation-control-information storing unit 307 in the operator supporting apparatus 300 stores the operation item and the dialog scenario of the operator in association with each other. The dialog scenario information providing unit 308 specifies the dialog scenario corresponding to the operation item by using the cooperation-control-information storing unit 307, and displays the specified dialog scenario on the dialog scenario screen 230. As a result, the dialog scenario corresponding to the operation performed by the operator on the client information screen 210 or the transaction screen 220 is automatically displayed on the dialog scenario screen 230, thereby reducing the workload of the operator in operating the dialog scenario screen 230, while operating the client information screen 210 and the transaction screen 220.

According to the first embodiment, the cooperation-control-information storing unit 307 in the operator supporting apparatus 300 stores the operation item and the dialog scenario of the operator in association with each other. The dialog scenario information providing unit 308 specifies the operation item corresponding to the dialog scenario by using the cooperation-control-information storing unit 307, and transmits the specified operation item to the cooperation apparatus 400. As a result, the operator can obtain the transaction screen corresponding to the dialog scenario, by designating the dialog scenario, thereby reducing the workload of the operator in operating the transaction screen 220, while operating the dialog scenario screen 230.

According to the first embodiment, an example in which the operator supporting apparatus 300 and the cooperation apparatus 400 are separately provided is explained, but the present invention is not limited thereto, and is also applicable to an example in which the support apparatus 300 and the cooperation apparatus 400 are incorporated in one apparatus.

According to the first embodiment, an example in which the client information providing unit 302, the transaction information providing unit 304, the dialog scenario information providing unit 308, and the call managing unit 311 are operated by the operator supporting apparatus 300 is explained. However, the present invention is not limited thereto, and is also applicable to an example in which they are divided into a plurality of apparatus and operated, together with the databases and storage units used by these processors.

According to the first embodiment, an example in which cooperation between the screens is performed by using the cooperation apparatus 400 is explained, but the present invention is not limited thereto, and is also applicable to an example in which the client information providing unit 302, the transaction information providing unit 304, and the dialog scenario information providing unit 308 directly perform cooperation of the screen with one another. However, the functions provided by the client information providing unit 302, the transaction information providing unit 304, and the dialog scenario information providing unit 308 are built as an independent system in many cases, and by using the cooperation apparatus 400, the call center system according to the present invention can be realized without largely recreating these existing independent systems.

According to the first embodiment, an example in which the dialog scenario information providing unit 308 displays the dialog scenario corresponding to the operation of the operator and passes the tag to the call managing unit 311 is explained. However, the present invention is not limited thereto, and is also applicable to an example in which a functional unit that passes the tag corresponding to the operation of the operator to the call managing unit 311 is separated from the dialog scenario information providing unit 308.

According to the first embodiment, an example in which an apparatus that has a telephone function for placing a call by using the Internet, such as the IP telephone, is used as a client terminal is explained. However, the present invention is not limited thereto, and is also applicable to an example in which the client uses a telephone using line switching, by providing in the call center a converter that converts from the line switching to packet communication.

According to the first embodiment, the operator supporting apparatus is explained, but by realizing the configuration included in the operator supporting apparatus by the software, an operator supporting program having the same function can be obtained. Therefore, a computer system that executes the operator supporting program will be explained next.

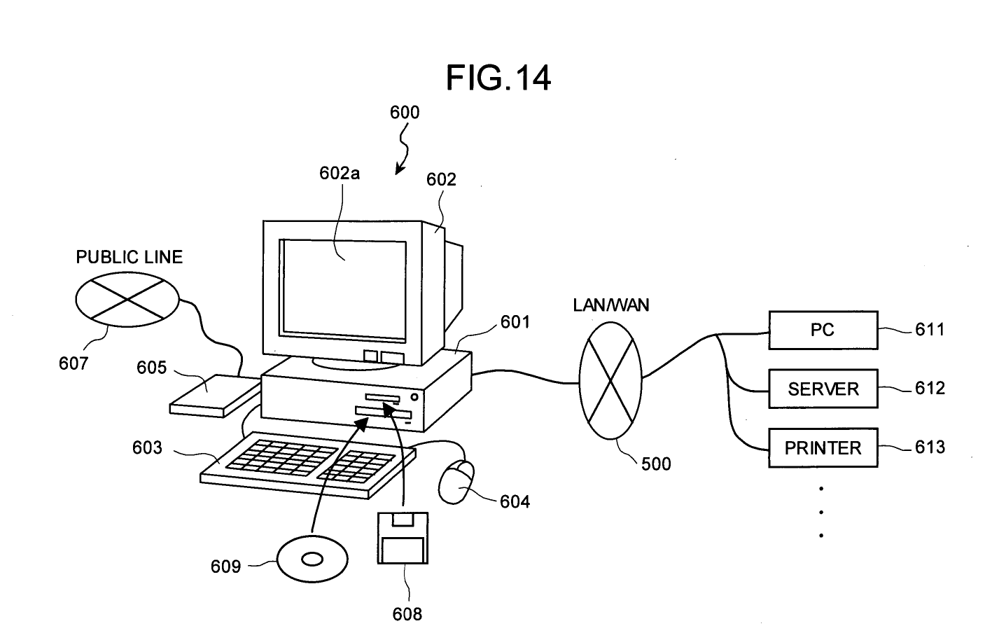

FIG. 14 depicts the computer system that executes the operator supporting program according to the first embodiment. As shown in the drawing, a computer system 600 includes a main unit 601, a display 603 that displays information on a display screen 602a according to an instruction from the main unit 601, a keyboard 603 for inputting various kinds of information to the computer system 600, a mouse 604 for specifying an optional position on the display screen 602a on the display 602, a LAN interface for the connection with a LAN 500 or a wide area network (WAN), and a modem 605 for the connection with a dynamic communication network 607. Here, the LAN 500 connects the computer system 600 to another computer system (PC) 611, a server 612, a printer 613, and the like.

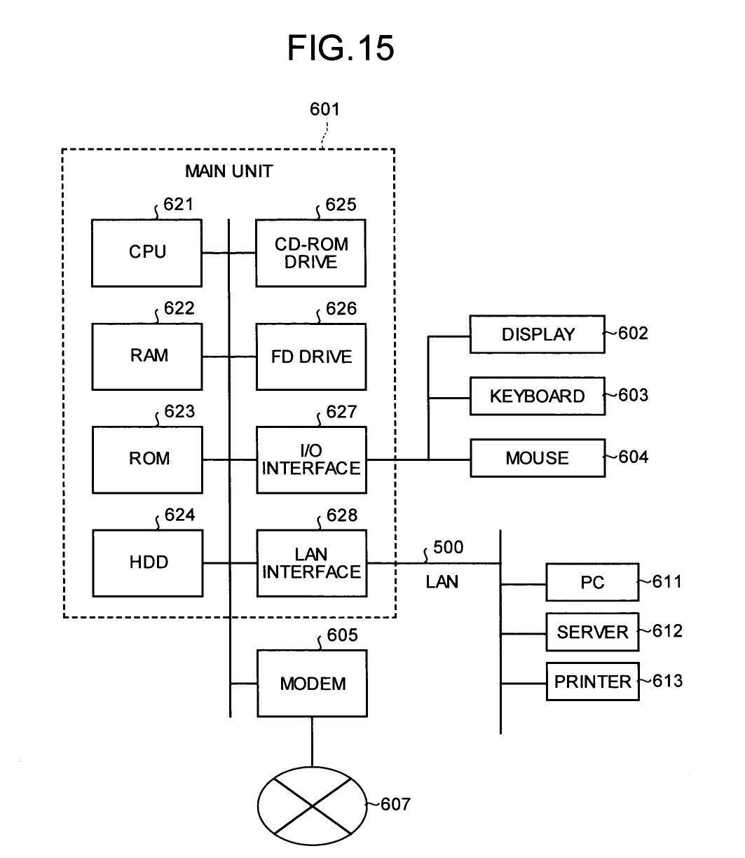

FIG. 15 is a functional block diagram of the configuration of the main unit 601 shown in FIG. 14. As shown in the drawing, the main unit 601 has a CPU 621, a RAM 622, a ROM 623, a hard disk drive (HDD) 624, a CD-ROM drive 625, an FD drive 626, an I/O interface 627, and a LAN interface 628.

The operator supporting program executed in the computer system 600 is stored in a portable storage medium such as a floppy disk (FD) 608, a CD-ROM 609, a DVD disk, a magneto-optic disk, and an IC card, read from the storage medium, and installed in the computer system 600.

Alternatively, the operator supporting program is stored in a database in the server 612 connected via the LAN interface 628, or a database in the other computer system (PC) 611, read from the database, and installed in the computer system 600.

The installed operator supporting program is stored in the HDD 624, and executed by the CPU 621 by using the RAM 622, the ROM 623, and the like.

In the first embodiment, the processing of the call center system relating to the call between the client and the operator is mainly explained. However, the call center system needs to perform processing other than the processing relating to the call between the client and the operator. Therefore, in a second embodiment of the present invention, wide range of processing of the call center system including the processing other than that relating to the call between the client and the operator will be explained.

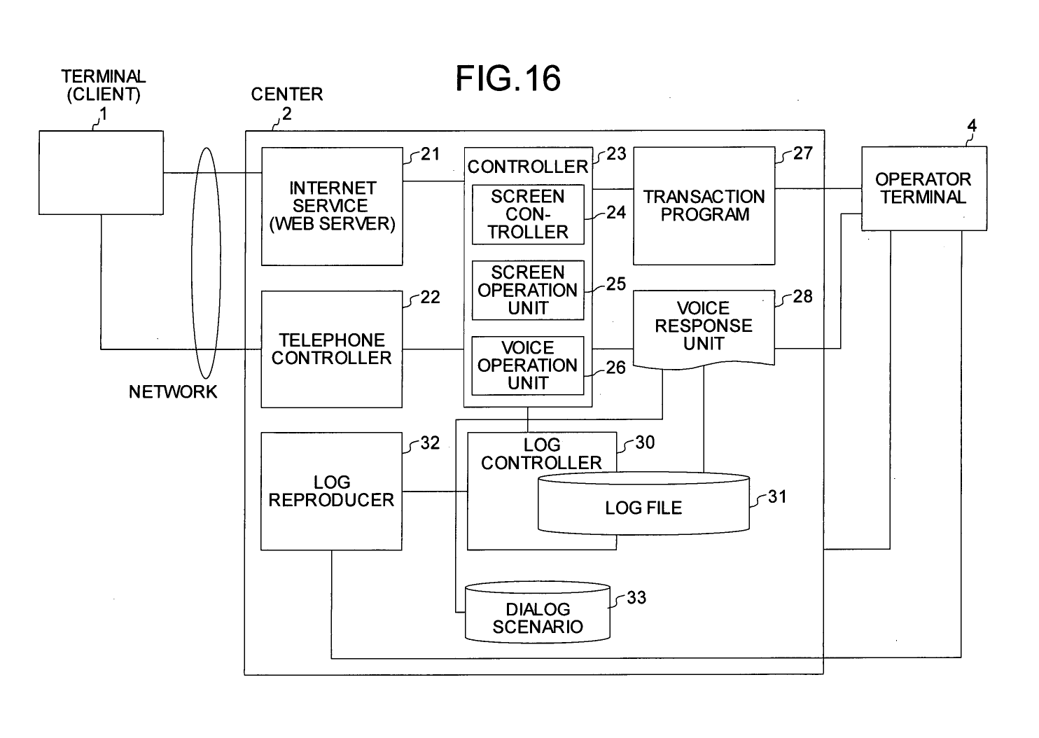

The system configuration and the operation of a call center system according to the second embodiment will be explained in detail sequentially with reference to FIGS. 16 to 23.

FIG. 16 is a functional block diagram of the system configuration of the call center system according to the second embodiment. A terminal 1 (with a telephone) is connected to a center (call center) 2 via a network by a client, and the client receives service for a product by talking over the telephone with the center 2 by the terminal.

The center 2 is connected to the client terminal 1 via the network and provides the service for the product by talking over the telephone with the client. Here, the center includes an Internet service (Web server) 21, a telephone controller 22, a controller 23, a transaction program 27, a voice response unit 28, a log controller 30, a log file 31, a log reproducer 32, and a dialog scenario 33.

When connected to the client terminal 1 via the network, the Internet service (Web server) 21 allows the terminal 1 to download and display a screen for selecting transactions and the like, and allows the client to select a transaction from the displayed screen.

The telephone controller 22 is connected to the client terminal 1 via the network for the conversation between the center 2 and the client (for example, performs control for talking with the client with a VoIP telephone).

The controller 23 is connected to the client terminal 1, to record the conversation with the client as a log in the log file 31 or reproduce the log, and includes a screen controller 24, a screen operation unit 25, and a voice operation unit 26.

The screen controller 24 controls the configuration of the screen of an operator terminal 4.

The screen operation unit 25 obtains an operated log and records the log in the log file 31, when the operator operates the screen of the operator terminal 4 (that is, inputs in an input field on the transaction screen displayed by the screen controller 24, or depresses a button).

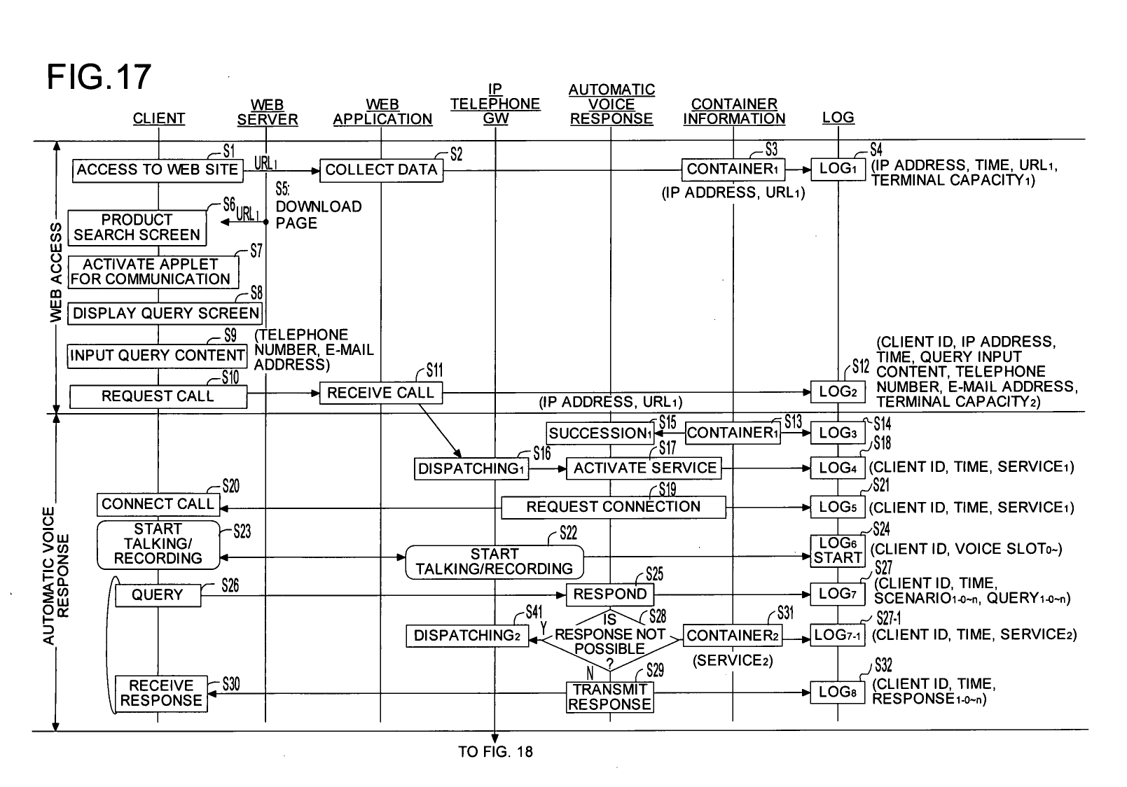

The voice operation unit 26 exchanges speech with a telephone of the client terminal 1 via the telephone controller 22 (that is, refers to the dialog scenario 33 to present a response to a query from a client with respect to the operator, or adds a title (tag) to the speech and recording it in the log file via the log controller 30) (which will be explained later with reference to FIGS. 17 to 23).

The transaction program 27 is for displaying information necessary for the operator to perform transactions of goods or provide services on the screen of the operator terminal 4, or prompting the operator to input necessary information.

The voice response unit 28 exchanges information with the client terminal 1 by speech (for example, responds in speech with respect to a voice query of a client).

The log controller 30 controls storage of the dialog information at the time of talking with the client in the log file 31 as a log corresponding to the input/output information, or readout of the log from the log file 31.

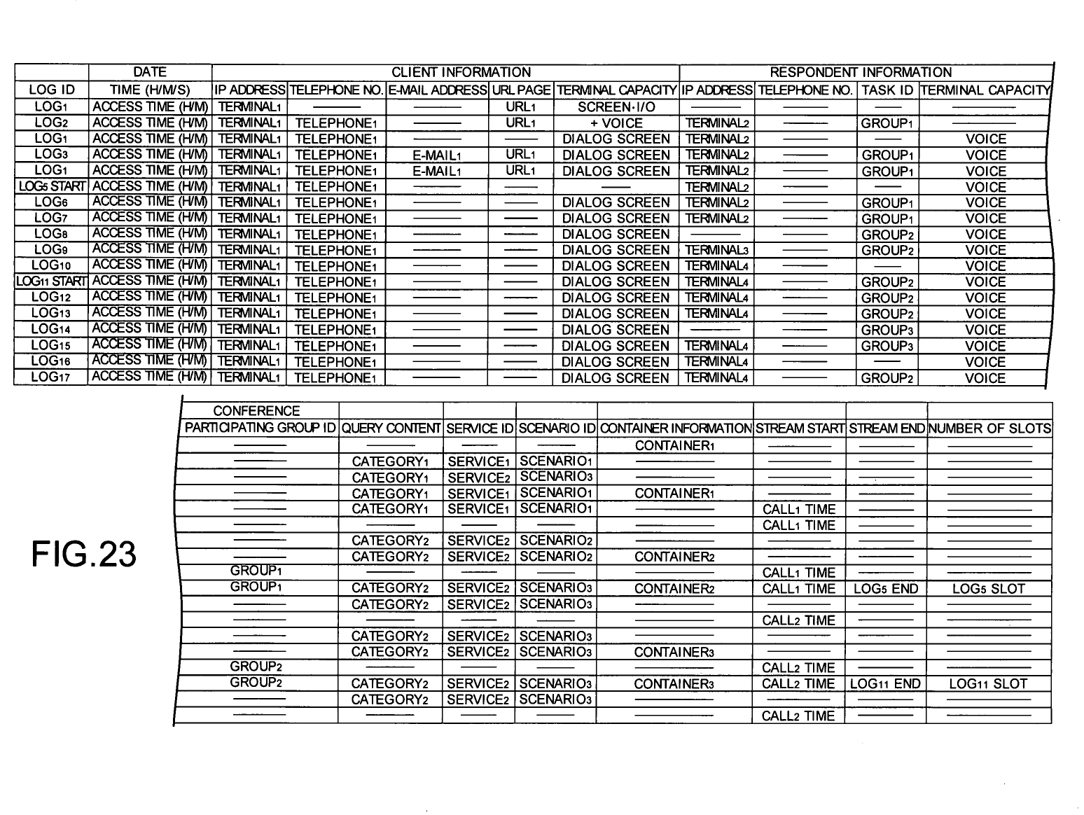

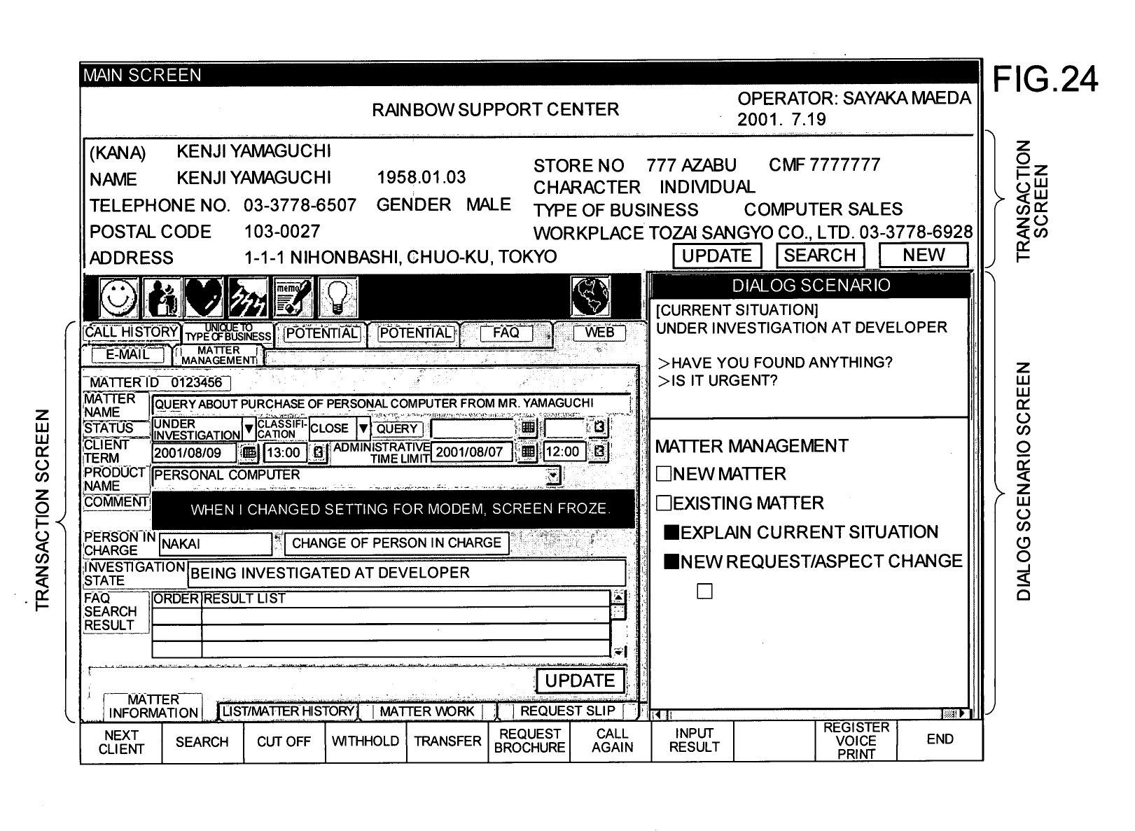

The log file 31 is used for recording the contents of conversation between the client and the center 2 as a log (see FIG. 23).

The log reproducer 32 reproduces the log for the reproduction of the conversation and the input/output information associated with each other.

The dialog scenario 33 is obtained by registering responses associated with queries.

The operator terminal 4 performs various kinds of responses, such as assembling and displaying response information via the voice response unit 28 based on the information of the dialog scenario, and transmitting the response in speech or characters, with respect to queries from the client.

The operation in the configuration shown in FIG. 16 will be explained in detail, referring to FIG. 17 to FIG. 19. Here, the client on the upper line in FIGS. 17 to 19 is a client who operates the terminal 1 in FIG. 16 to talk to the center 2 via the network. The Web server is the Internet service (Web server) 21 in FIG. 16. The Web application is the controller 23 in FIG. 16 or the like. The IP telephone GW is the telephone controller 22 in FIG. 16 or the like for placing an IP call. The automatic voice response is the voice response unit 28 in FIG. 16. The container information is information obtained by storing collected information in a container. The log is recorded in the log file 31 in FIG. 16.

FIGS. 17 to 19 are flowcharts for explaining the operation of the call center system according to the second embodiment.

In FIG. 17, at S1, the client operates the terminal 1 to access a website (here, URL₁).

At S2, a Web application collects data. Here, the Web application collects the URL, to which the client has accessed at S1, the IP address of the client, and the like.

At S3, the data collected by the Web application at S2 is generated as a container₁ (container information).

At S4, the log controller 30 records the container₁ generated at S3 as a log₁ in the log file 31. Here, the following shown information is recorded as the log₁ in the log file 31.
IP address (IP address of the client terminal 1):
Time (accessed time):
URL₁ (URL of the website):
Terminal capacity₁ (capacity of the client terminal 1, for example, the number of pixels of the screen of the terminal 1, LAN connection, and the like):
Others:

At S5, the terminal 1 downloads the page in the URL₁.

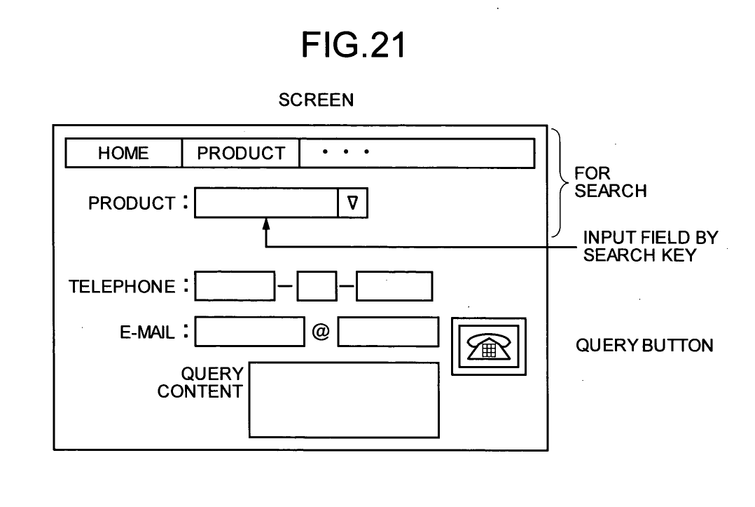

At S6, the terminal 1 displays a product search screen downloaded at S5 on the display unit. For example, the terminal 1 displays the product search screen on the upper section on the screen shown in FIG. 21.

At S7, the terminal 1 activates an applet for communication.

At S8, the terminal 1 displays a query screen, according to the activation at S7.

At S9, the client inputs a query content.

At S10, the client places a call. At steps from S7 to S10, for example as shown on the lower section on the screen in FIG. 21 explained later, the client inputs the telephone number, an e-mail address, and the query content for making a query, and depresses a query button, to place a call.

At S11, the Web application receives the request transmitted at S10 via the Web server.

At S12, the log controller 30 records the following information received at S11 as a log₂ in the log file 31.
Client ID:
IP address (client terminal 1):
Time (reception time):
Query content:
Telephone number:
E-mail address:
Terminal capacity₂ (the number of pixels of the screen of the client terminal 1, LAN connection, and the like):
Others:

At steps from S1 to S12, a series of processing corresponding to the Web access is executed, and the log, and the log₂ are respectively recorded in the log file 31.

At S13, the Web application sends information of the container₁ to the automatic voice response, and also to the log controller 30 as a log₃.

At S14, the log controller 30 records the container₁ received at S13 as the log₃ in the log file 31.

At S15, the automatic voice response recognizes the container₁ sent at S13 as a succession₁. By steps from S13 to S15, the automatic voice response recognizes the previous container₁ as the succession₁, and the log controller 30 records it in the log file 31 in association with the current time (time stamp).

At S16, in order to activate the IP telephone requested at the time of reception, corresponding to the reception at S11, the Web application activates the IP telephone GW as dispatching₁.

At S17, the IP telephone GW activates the service by the automatic voice response succeeded by the succession, at S15 corresponding to the activation at S16.

At S18, the log controller 30 records the information (here, client ID, time, and service₁) at steps S16 and S17 as a log₄ in the log file 31.

At S19, the automatic voice response requests connection with the client terminal 1 by the VoIP.

At S20, the call from the client terminal 1 is connected to the automatic voice response by the VoIP.

At S21, the log controller 30 records the information (here, client ID, time, and service₁) at steps S19 and S20 as a log₅ in the log file 31.

At steps from S22 to S24, the IP telephone GW initiates the talk with the client, and starts to record the conversation, and the log controller 30 records the conversation as a log₆ (client ID, voice slot₀₋ₙ) in the log file 31.

At steps from S25 to S27, the automatic voice response refers to the dialog scenario 33 with respect to the query from the client, to search if a response to the query is registered, and the log controller 30 records a log₇ (client ID, time, scenario₁₋₀₋ₙ, query₁₋₀₋ₙ) in the log file 31.

At S28, the automatic voice response determines whether a response is not possible since the response is not registered in the dialog scenario 33. If YES, since the response for the client's query is not registered in the dialog scenario 33, and the automatic voice response determines that the response is not possible, at S41, the automatic voice response proceeds to dispatching₂ (response by the operator). At this time, the Web application generates a container₂ (service₂ in which the response cannot be transmitted at S25) for the information succeeded at this time at S31 explained later, and at S27-1, the log controller 30 records it as a log₇₋₁ (client ID, time, and service₂) in the log file 31. On the other hand, if NO at S28, since the response to the client's query is registered in the dialog scenario 33, at S29, the automatic voice response transmits the response to the client. At S30, the client receives the transmitted response, to return to S26 to repeat the step. Further, at S31, the Web application generates a container₂ (service₂ in which the response is transmitted at S29), and at S32, the log controller 30 records it as a log₈ (client ID, time, service₂, and response₁₋₀₋ₙ) in the log file 31.

At steps from S13 to S32 and S41, the processing corresponding to a series of automatic voice response is executed, to record the log₃ to the log₈ in the log file 31, respectively.

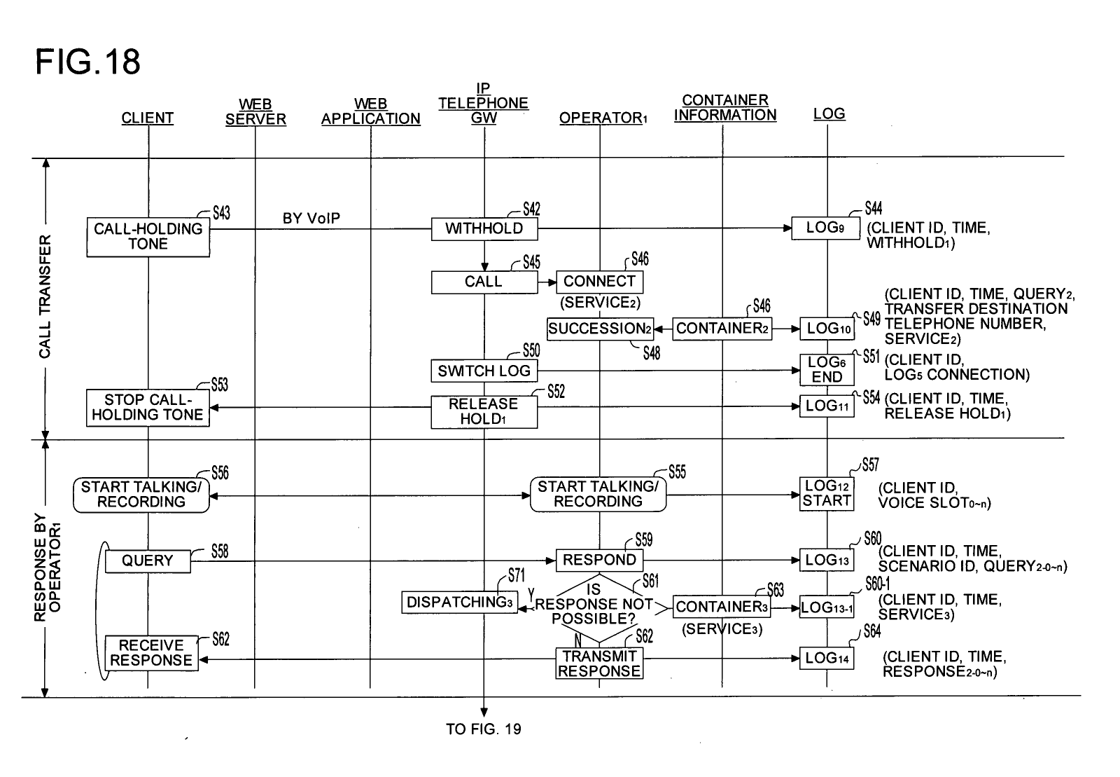

In FIG. 18, at S42, the IP telephone GW withholds the IP telephone, corresponding to the dispatching₂ at S41 in FIG. 17. As a result, at S43, call-holding tone is generated from the IP telephone of the client terminal 1, and at S44, the log controller 30 records the information at this time as a log₉ (client ID, time, hold₁) in the log file 31.

At steps S45 and S46, the IP telephone GW calls the operator, and establishes the connection by VoIP.

At steps from S47 to S49, the Web application reads the container₂ (information recorded in the log file 31 as the log₈ at S31 in FIG. 17), and presents it to the operator₁ as the successions, and the log controller 30 records it as a log₁₀ in the log file 31.

At steps S50 and S51, the IP telephone GW switches the log, so that the log controller 30 terminates the log₆ started at S24 in FIG. 17, to finish recording of the voice slot.

At steps from S52 to S54, the IP telephone GW releases hold₁ of the IP telephone, and stops the call-holding tone to the client terminal 1, and the log controller 30 records it as a log₁₁ (client ID, time, hold release₁) in the log file 31.

By the steps from S42 to S54, the processing of a series of call transfer (call transfer from the automatic voice response to the operator₁) is executed, and the matter that cannot be dealt by the automatic voice response is succeeded to the operator₁ by the containers. Further, the log₉ to the log₁₁ are respectively recorded in the log file 31.

At steps from S55 to S57, corresponding to the hold release at S52, the operator₁ starts talking with the client, the Web application starts recording, and the log controller 30 starts to record a log₁₂ (client ID, voice slot₀₋ₙ) in the log file 31.

At steps from S58 to S60, the client puts a query to the operator₁, and the operator₁ refers to the knowledge and database, not shown, to determine whether a response is not possible, and the log controller 30 records a log₁₃ (client ID, time, scenario ID, and query₂₋₀₋ₙ) in the log file 31.

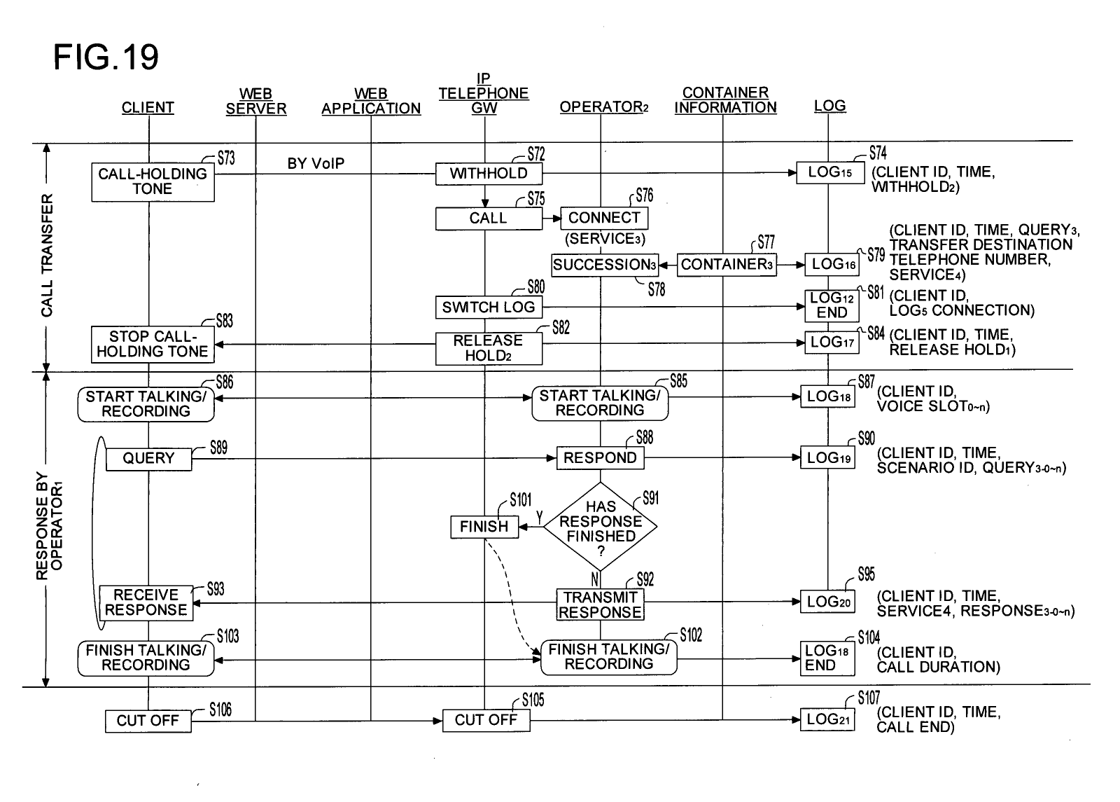

At S61, the operator₁ determines whether a response is not possible. If determined YES, since it is found that the response to the client's query is not possible, control proceeds to dispatching₃ at S71, and the call is transferred to another operator₂ having the knowledge at S72 and thereafter in FIG. 19. The Web application generates the information at this time as a containers, and the log controller 30 records a log₁₃₋₁ (client ID, time, and service₃) in the log file 31. If determined NO at S61, since it is found that the response to the client's query is possible, control proceeds to S62.

At steps from S62 to S64, since it is found that the response is possible by the judgment of NO at S61, the operator, transmits the response (service₃) to the client, and the client receives the response. The Web application generates the information at this time as a containers, and the log controller 30 records a log₁₄ (client ID, time, service3, and response₂-O-n) in the log file 31. Then, steps at S58 and thereafter are repeated.

By the steps from S55 to S64 and S71, the processing of a series of correspondence by the operator, (response to the query of the client by the operator₁) is executed, and the log₁₂ to the log₁₄ are respectively recorded in the log file 31.

In FIG. 19, at S72, the IP telephone GW withholds the IP telephone, corresponding to the dispatching₃ at S71 in FIG. 18. As a result, at S73, call-holding tone is generated from the IP telephone of the client terminal 1, and at S74, the log controller 30 records the information at this time as a log₁₅ (client ID, time, hold₂) in the log file 31.

At steps S75 and S76, the IP telephone GW calls the operator₂ and establishes the connection by VoIP.

At steps from S77 to S79, the Web application reads the containers (information recorded in the log file 31 as the log₁₃₋₁ at S63 in FIG. 18), and presents it to the operator₂ as the successions, and the log controller 30 records it as a log₁₆ in the log file 31.

At steps S80 and S81, the IP telephone GW switches the log, so that the log controller 30 terminates the log₁₂ started at S57 in FIG. 18, to finish recording of the voice slot.

At steps from S82 to S84, the IP telephone GW releases hold₂ of the IP telephone, and stops the call-holding tone to the client terminal 1, and the log controller 30 records it as a log₁₇ (client ID, time, hold release₂, and terminal capacity) in the log file 31.

By the steps from S72 to S84, the processing of a series of call transfer (call transfer from the operator, to the operator₂) is executed, and the log₁₅ to the log₁₇ are respectively recorded in the log file 31.

At steps from S85 to S87, corresponding to the hold release₂ at S82, the operator₂ starts talking with the client, the Web application starts recording, and the log controller 30 starts to record a log₁₈ (client ID, voice slot₀₋ₙ) in the log file 31.

At steps from S88 to S90, the client puts a query to the operator₂, and the operator₂ refers to the knowledge and database, not shown, to determine whether a response is not possible, and the log controller 30 records a log₁₉ (client ID, time, scenario ID, and query₃₋₀₋ₙ) in the log file 31.

At S91, the operator₂ determines whether a response has finished. If determined YES, since it is found that the response to the client's query has finished, the processing ends at S101, and steps from S102 to S107 are executed. If determined NO at S91, since it is found that the response to the client's query has not finished yet, control proceeds to S92.

At steps from S92 to S95, since it is found that the response has not finished yet due to the judgment of NO at S91, the operator₂ transmits the response to the client, the client receives the response (service₄), and the log controller 30 records a log₂₀ (client ID, time, response₃₋₀₋ₙ) in the log file 31. Steps at S89 and thereafter are repeated.

At steps from S102 to S104, since the response by the operator₂ has finished at S101, the operator₂ and the client finish talking, the Web application finishes recording, and the log controller 30 records it as log₁₆ end (client ID, call duration) in the log file 31.

At steps from S105 to S107, corresponding to the end of talking and recording, the IP telephone GW disconnects the IP telephone and the log controller 30 records a log₂₁ (client ID, time, call end) in the log file 31.

By the steps from S85 to S95, and S101 to S104, the processing of a series of correspondence by the operator₂ (response to the query of the client by the operator₂) is executed, and the log₁₈ to the log₂₀ are respectively recorded in the log file 31.

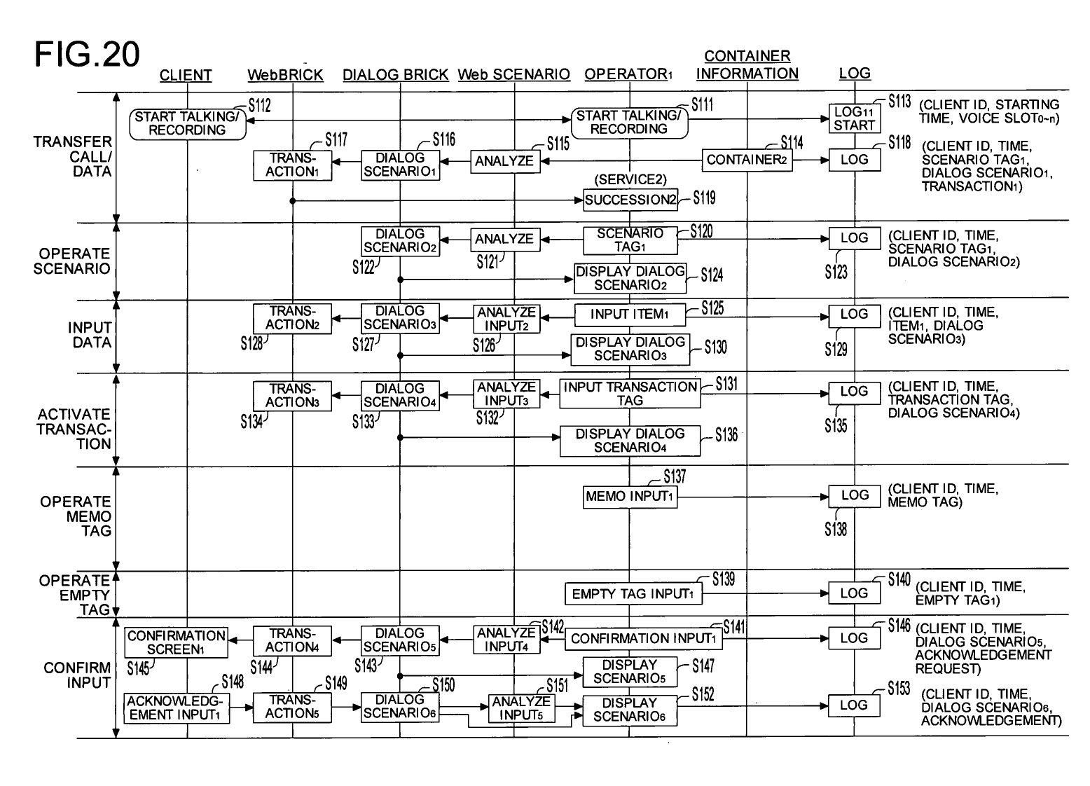

FIG. 20 is a flowchart for explaining the details of an operation associated with the operator, in the call center system according to the second embodiment.

In FIG. 20, at steps from S111 to S113, the operator₁ and the client starts talking, a Web scenario starts recording, and the log controller 30 records it as log₁₁ start (client ID, starting time, voice slot₀₋ₙ) in the log file 31.

At steps from S114 to S118, the container₂ (contents (client ID, time, service₂, response₁₋₀₋ₙ) recorded in the log file 31 as the log₈ at S31 in FIG. 17) is read, and the Web scenario analyzes the contents of the containers, for example, the Web scenario excludes a response by the automatic voice response with respect to the client's query being OK (the client is satisfied with the response), and takes out a response being NG (the client is not satisfied with the response), refers to the dialog scenario, not shown, to fetch a dialog scenario, (for example, “please ask the client about ∘∘”), and activates a transaction, associated with the query. The log controller 30 then records it as a log (client ID, time, query₂ that cannot be responded, dialog scenario 1 to be asked to the client, and transaction₁).

At S119, the Web scenario transfers and presents information about the client query that cannot be fully responded by the automatic voice response to the operator, as a successions.

By the steps from S111 to S119, call transfer becomes possible, that is, the information (the log at S118) about the client query that cannot be responded by the automatic voice response can be transferred and presented to the operator₁ (call data transfer).

At steps from S121 to S124, when the operator₁ presented with the succession₂ at S119 sets a scenario tag₁ at a position of an important query in the presented dialog scenario, the Web scenario fetches the content at the position of the set scenario tag₁ (an important portion (for example, “personal computer”) in the client's query), and fetches a relevant dialog scenario₂ from the dialog scenario, not shown, (for example, detailed information constituting the personal computer, such as a CPU, a memory and the like, with respect to “the personal computer”, is fetched as the dialog scenario₂), to display the dialog scenario₂ to be asked to the client. The log controller 30 then records it as a log (client ID, time, scenario tag₁, and dialog scenario₂) in the log file 31.

By the steps from S111 to S124, when the operator, performs scenario operation, that is, specifies the presented important portion in the client's query, which has not been solved by the automatic voice response, the Web scenario fetches detailed information to be asked to the client for the important portion as a dialog scenario₂, and presents dialog scenario₂ to the operator₁, and the log controller 30 can record it as a log.

At steps from S125 to S130, since an input field is displayed on the lower section in the dialog scenario₂ displayed at S124, the operator₁ key-inputs an item₁, which is a problematic point in the client's query that has not been solved yet (for example, name of new software). The Web scenario then analyzes the input item₁ to fetch a relevant dialog scenario₃ from the dialog scenario, not shown, and displays the dialog scenario₃ to be asked to the client. The log controller 30 then records it as a log (client ID, time, item₁, and dialog scenario₃) in the log file 31.

By the steps from S125 to S130, when data is input, that is, the operator₁ further inputs the item, to be asked to the client in the presented scenario₂, the Web scenario can fetch and present detailed information to be asked to the client with respect to the item, as the dialog scenario₃, and the log controller 30 can record it as a log.

At steps from S132 to S136, the operator, inputs further necessary detailed information (input₃) in the information to be asked to the client, displayed in the dialog scenario₃ displayed at S130, and the Web scenario analyzes this, fetches and displays a relevant dialog scenario₄ from the dialog scenario, not shown. The log controller 30 then records a log (client ID, time, transaction tag, and dialog scenario₄) in the log file 31.

By the steps from S132 to S136, when the transaction is activated, that is, the operator, inputs a transactions tag to be asked in more detail in the presented scenario₃, the Web scenario fetches and displays detailed information to be asked to the client about the transaction₁ as the dialog scenario₄, and the log controller 30 can record is as a log.

At steps of S137 and S138, when the operator₁ refers to the scenario₄ and inputs a memorandum (important information in the conversation with the client, to be recorded) on the lower section in the relevant portion in the scenario₄, the log controller 30 records a log (client ID, time, and memo tag) in the log file 31 (memo tag operation).

At S139, when the operator₁ refers to the scenario₄, depresses an ENTER key and records that the relevant portion in the conversation is an important portion, during the conversation with the client, when there is no time to input it as a memorandum, the log controller 30 records a log (client ID, time, and empty tag₁) in the log file 31 (empty tag operation).

At steps from S141 to S147, the operator₁ selects or inputs all items (input₄) confirmed in the conversation with the client so far, and the Web scenario analyzes the input₄ to create and display a dialog scenario₅, and also displays it on a confirmation screen₁ of the client. The log controller 30 then records a log (client ID, time, dialog scenario₅, and acknowledgement request) in the log file 31.

At steps from S148 to S153, when the client inputs acknowledgement (acknowledgement input₁), the Web scenario generates and displays a dialog scenario₆ and performs analysis, and log controller 30 records a log (client ID, time, dialog scenario₆, and acknowledgement) in the log file 31 (input confirmation).

FIG. 21 is an example of a screen displayed on the client terminal 1 according to the second embodiment. The upper section in the screen shows an example of a product search screen displayed at S6 in FIG. 17, and here, it is a screen having an input field for selecting a product to be purchased.

The lower section in the screen shows an example of a query screen displayed at S8 in FIG. 17, and here, it is a screen having an input field for inputting the telephone number and the e-mail address of the client, and the query content.

On the screen, the client inputs personal client information, and can select and input the information of the inquired product.

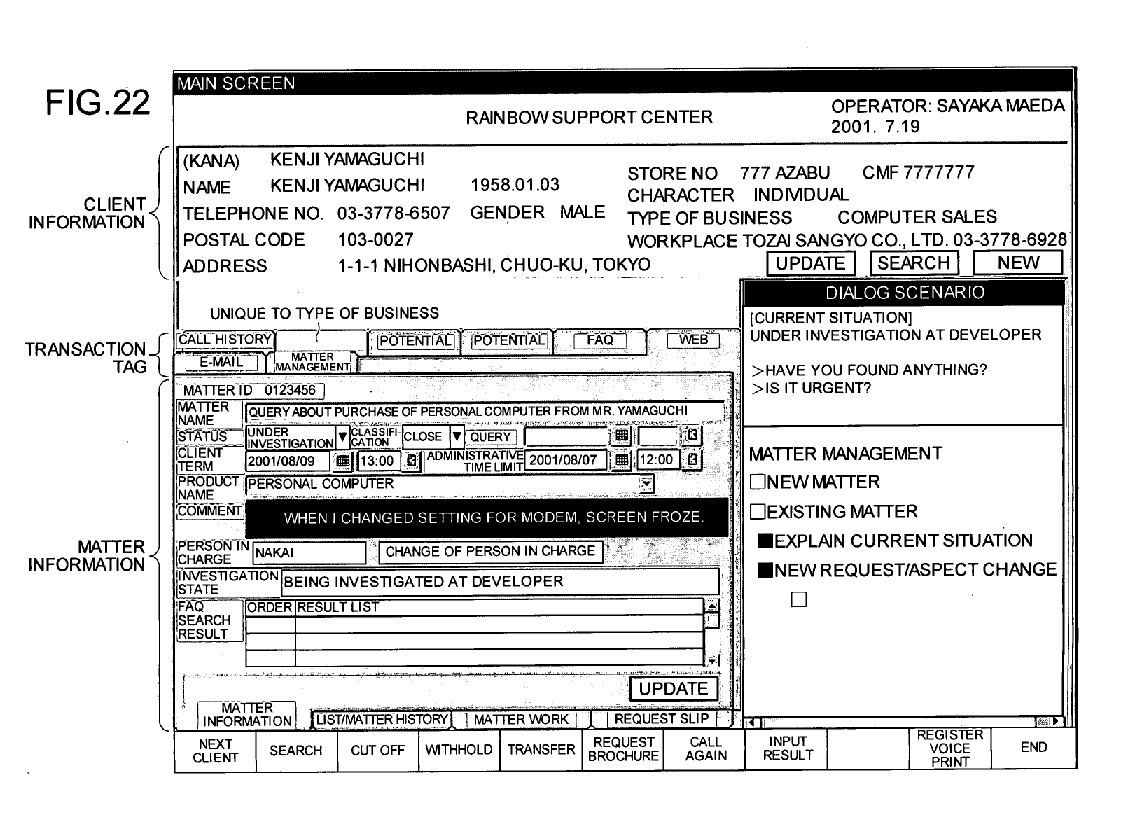

FIG. 22 is an example of a screen displayed on the operator terminal 4 according to the second embodiment.

In FIG. 22, the upper section in the screen is a portion for displaying the client information, and here, the client information of a client, “Kenji YAMAGUCHI” is displayed.

The middle and the lower sections on the right side on the screen are portions for displaying the dialog scenario, and here, the current situation, for example, the followings are displayed:
Being investigated at the developer
Have you found anything?
Is it urgent?

The middle and the lower sections on the left side on the screen are portions for displaying the matter information with respect to the client, and here, the followings are displayed:
Matter ID:
Matter name:
Status:
Client term:
Product name:
Comment: When I changed the setting for the modem, the screen froze.
Person in charge:
Investigation state: Being investigated at the developer
FAQ: Result list
Search result:
Others.

The call center system according to the second embodiment displays the client information, the dialog scenario, and the matter information in association with one another. As a result, the call center system can efficiently provide various kinds of services to the clients, by the automatic voice response or the operator response, according to the flowcharts shown in FIG. 17 to FIG. 20.

FIG. 23 is an example of a log according to the second embodiment. The logs shown in the drawing are those recorded in the log file 31, and here, the followings are recorded:
Log ID:
Date and time:
Client information:
   IP address:
   Telephone number:
   E-mail address:
   URL page:
   Terminal capacity (number of pixels of the screen, I/O type, LAN connection, etc.):
Respondent information (operator responding to the client):
   IP address (IP address of the used terminal):
   Telephone number:
   Task ID:
   Terminal capacity (voice, etc.):
Group attending the meeting:
Query content:
Service ID:
Scenario ID:
Container information:
Initiation of stream (initiation of voice conversation):
Termination of stream (termination of voice conversation):
Number of slots (number of slots including conversation):
Others.

According to the call center system in the second embodiment, the above information is recorded in the log file 31 and referred, and logs in the respective situations, for example, at the time of automatic voice response to the client, or voice response by the operator₁ and the operator₂ are recorded, so that other operators can refer to the logs at the time of voice response thereafter to respond to the client appropriately.

According to the second embodiment, such a configuration is adopted that the conversation between the client and the center 2 is recorded in the log file 31 as a log for each predetermined period, and the conversation and the client information are associated with the input/output information and recorded, so that a target log can be searched according to need and the relevant information is presented. As a result, the center 2 can appropriately respond to a client's query by the automatic voice response or by the operator, the client's query can be reproduced and appropriately handled, and only the target log can be taken out to perform trend analysis of the client.

According to the present invention, the operator stores a call content identifier added to the call recording corresponding to the operation performed by the operator with respect to the operator terminal during the call, so as to facilitate specifying a spot to be played when the recorded call is partially played. When the operator performs an operation with respect to the operator terminal during the call, using the stored information, the call content identifier corresponding to the operation of the operator is specified, and the specified call content identifier is added to the call recording. As a result, the workload of the operator in the post-processing to be performed by using the call recording after finishing the call with the client is reduced, thereby improving the work efficiency of the operator.

The transaction screen to be used by the operator at the time of processing the client's matter during the call with the client, and the dialog scenario screen to be used at the time of using the dialog scenario are displayed, the displayed dialog scenario and the information of the operation performed by the operator during the call are associated with each other and transmitted to the operator supporting apparatus, the dialog scenario screen specified by the transmitted operation information is received from the operator supporting apparatus, and the operator terminal displays the received dialog scenario on the dialog scenario screen. As a result, the workload of the operator in the screen operation performed during the call with the client can be reduced, thereby improving the work efficiency of the operator.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An operator supporting apparatus that displays information for supporting an operator who talks over a telephone with a client in a call center on an operator terminal, and records a call between the operator and the client, the operator supporting apparatus comprising:
a cooperation-control-information storing unit that stores a call content identifier that is to be added to a call recording to specify a spot to be played when the call recorded is partially played, in association with an operation performed by the operator on the operator terminal during the call;
an identifier specifying unit that specifies, when the operator operates the operator terminal during the call, the call content identifier corresponding to the operation performed by the operator; and
an identifier adding unit that adds the call content identifier specified by the identifier specifying unit to the call recording.

2. The operator supporting apparatus according to claim 1, further making the computer execute:
a scenario specifying unit that specifies a dialog scenario corresponding to the operation performed by the operator; and
a scenario displaying unit that displays the dialog scenario specified on the operator terminal, wherein
the cooperation-control-information storing unit further stores the dialog scenario created by assuming the call with the client in advance, in association with the operation performed by the operator.

3. An operator support terminal comprising:
a first screen display unit that displays a transaction screen that is used when an operator processes a business of a client during a call with the client and a dialog scenario screen that is used when the operator uses a dialog scenario;
a transmitting unit that transmits, to an operator supporting apparatus, the dialog scenario displayed on the dialog scenario screen and information on an operation performed by the operator during the call on the transaction screen, in association with each other;
a receiving unit that receives, from the operator supporting apparatus, the dialog scenario screen specified by the information transmitted by the transmitting unit; and
a second screen display unit that displays the dialog scenario received by the receiving unit on the dialog scenario screen.

4. An operator support method of displaying information for supporting an operator who talks over a telephone with a client in a call center on an operator terminal, and recording a call between the operator and the client, the method comprising:
specifying, when the operator operates the operator terminal during the call, a call content identifier corresponding to an operation performed by the operator by using a cooperation-control-information storing unit in which the call content identifier that is to be added to a call recording to specify a spot to be played when the call recorded is partially played is stored in association with the operation performed by the operator on the operator terminal during the call; and
adding the call content identifier specified by the identifier specifying unit to the call recording.

5. The operator support method according to claim 4, further comprising:
specifying a dialog scenario corresponding to the operation performed by the operator; and
displaying the dialog scenario specified on the operator terminal, wherein
the cooperation-control-information storing unit further stores the dialog scenario created by assuming the call with the client in advance, in association with the operation performed by the operator.

6. An operator support method of supporting an operator who talks over a telephone with a client in a call center by using an operator terminal that includes a transaction screen that is used when the operator processes a business of the client during a call with the client and a dialog scenario screen that is used when the operator uses a dialog scenario, the operator support method comprising:
transmitting, to an operator supporting apparatus, the dialog scenario displayed on the dialog scenario screen, and information of an operation performed by the operator during the call on the client information screen, in association with each other;
receiving, from the operator supporting apparatus, the dialog scenario specified by the information transmitted; and
displaying the dialog scenario received on the dialog scenario screen.

7. A computer-readable recording medium that stores an operator supporting program for displaying information for supporting an operator who talks over a telephone with a client in a call center on an operator terminal, and recording a call between the operator and the client, wherein the operator supporting program makes a computer execute
specifying, when the operator operates the operator terminal during the call, a call content identifier corresponding to an operation performed by the operator by using a cooperation-control-information storing unit in which the call content identifier that is to be added to a call recording to specify a spot to be played when the call recorded is partially played is stored in association with the operation performed by the operator on the operator terminal during the call; and
adding the call content identifier specified by the identifier specifying unit to the call recording.

8. The operator supporting program according to claim 7, wherein the operator supporting program further makes the computer execute
specifying a dialog scenario corresponding to the operation performed by the operator; and
displaying the dialog scenario specified on the operator terminal, and
the cooperation-control-information storing unit further stores the dialog scenario created by assuming the call with the client in advance, in association with the operation performed by the operator.

9. A computer-readable recording medium that stores an operator supporting program for supporting an operator who talks over a telephone with a client in a call center by using an operator terminal that includes a transaction screen that is used when the operator processes a business of the client during a call with the client and a dialog scenario screen that is used when the operator uses a dialog scenario, wherein the operator support program makes a computer execute
transmitting, to an operator supporting apparatus, the dialog scenario displayed on the dialog scenario screen, and information of an operation performed by the operator during the call on the client information screen, in association with each other;
receiving, from the operator supporting apparatus, the dialog scenario specified by the information transmitted; and
displaying the dialog scenario received on the dialog scenario screen.
